(19) United States
(12) Patent Application Publication
(10) Pub. No.: US 2026/0082002 A1
(43) Pub. Date: Mar. 19, 2026

(54) NON-TRANSITORY STORAGE MEDIUM STORING PROGRAM THAT SUPPORTS GENERAL-PURPOSE SCANNING SOFTWARE, METHOD, AND INFORMATION PROCESSING APPARATUS

(71) Applicant: CANON KABUSHIKI KAISHA, Tokyo (JP)

(72) Inventor: RYO DEGAWA, Ibaraki (JP)

(21) Appl. No.: 19/319,414

(22) Filed: Sep. 4, 2025

(30) Foreign Application Priority Data
Sep. 13, 2024 (JP) 2024-158729

(51) Int. Cl. H04N 1/00

(52) U.S. Cl. CPC H04N 1/00482; H04N 1/00811

(57) ABSTRACT

A method of supporting general-purpose software available to a plurality of image processing apparatuses manufactured by different manufacturers, the method includes displaying, on a display unit, a display screen to receive a brightness setting for an image of a document to be read by an image processing apparatus, and outputting a reading instruction to cause the image processing apparatus to initiate reading of the document in accordance with the brightness setting received through the display screen.

### BACKGROUND

### Field of the Technology

The present disclosure relates to a storage medium storing a program that supports general-purpose scanning software, a method, and an information processing apparatus.

### Description of the Related Art

A configuration in which a reading instruction is issued to a scanning device connected to a host computer by using a scanning driver installed on the host computer as scanning device control software is known. An operating system (OS), which is basic software, has been installed on the host computer, and the scanning driver is configured in accordance with specifications defined by the OS and is invoked by the OS to operate. By providing a user of the host computer with a scanning driver that conforms to the specifications of the OS, a vendor (manufacturer) that provides the scanning device can provide the user with a means for instructing the scanning device to perform a reading operation using the OS.

In recent years, Windows® has provided a standard-class driver (hereinafter also referred to as a “standard driver”) that can be used in common by scanning devices provided by a plurality of vendors. Such a standard driver is packaged with the OS and can be easily used by connecting any scanning device to a host computer. This eliminates the need to separately install a model-specific scanning driver suitable for the scanning device, which is highly convenient. The standard driver is expected to be configured in such a manner that scanning functions are able to be designated based on scanning function information generated based on information obtained from the connected scanning device. This configuration enables the user that uses the standard driver to designate scanning functions in accordance with the capabilities of the connected scanning device even though the user uses one standard driver. However, because the scanning functions that can be designated in this case are limited to the functions that can be realized only by the standard driver, functions unique to the vendor (manufacturer) of the scanning device are not able to be designated.

In this regard, Japanese Patent Laid-Open No. 2021-033526 describes a program for extending printing functions of general-purpose software.

An example of scanning driver functions unique to a vendor of a scanning device is a brightness adjustment function. The brightness adjustment function is a function for adjusting brightness of a read image.

However, in a case of using the standard driver, because the brightness adjustment function is unavailable, the user is unable to adjust brightness of an image.

### SUMMARY

In view of the above-described issues, the present disclosure provides a mechanism for extending commonly used scanning software functions across devices from a plurality of manufacturers to include a brightness adjustment function.

To solve the above-described issues, a program according to an aspect of the present disclosure includes the following configuration.

According to an aspect of the present disclosure, a non-transitory computer-readable storage medium storing a program for supporting general-purpose software compatible with a plurality of image processing apparatuses manufactured by different manufacturers, wherein the program, when executed by a computer, causes an information processing apparatus to perform a method includes causing a display unit to display a display screen to receive a brightness setting for an image of a document to be read by an image processing apparatus, and outputting a reading instruction to cause the image processing apparatus to initiate reading of the document in accordance with the brightness setting received through the display screen.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a hardware configuration of a scanning system according to a first embodiment.

FIGS. 2A and 2B are block diagrams each illustrating a software configuration of the scanning system according to the first embodiment.

FIG. 3A is a diagram illustrating an example of a scanning setting screen according to the first embodiment, and FIGS. 3B and 3C are diagrams each illustrating an example of an advanced setting screen according to the first embodiment.

FIG. 4 is a flowchart illustrating scanning function information editing processing that is performed by an extension application according to the first embodiment.

FIG. 5 is a diagram illustrating a list of scanning functions of each device according to the first embodiment.

FIG. 6 is a sequence diagram illustrating a scanning operation according to the first embodiment.

FIG. 7 is a flowchart illustrating the scanning processing that is performed by the extension application according to the first embodiment.

FIG. 8 is a flowchart illustrating the scanning processing that is performed by a scanning device according to the first embodiment.

FIG. 9 is a flowchart illustrating brightness adjustment function addition processing that is performed by an extension application according to a second embodiment.

FIG. 10 is a sequence diagram illustrating a scanning operation according to the second embodiment.

FIG. 11 is a flowchart illustrating scanning processing that is performed by the extension application according to the second embodiment.

FIG. 12 is a sequence diagram illustrating a scanning operation according to a third embodiment.

FIG. 13 is a sequence diagram illustrating the scanning operation according to the third embodiment.

FIG. 14 is a sequence diagram illustrating a scanning operation according to a fourth embodiment.

FIG. 15 is a flowchart illustrating scanning processing that is performed by an extension application according to the fourth embodiment.

FIGS. 16A and 16B are tables illustrating capability information lists according to a fifth embodiment, and FIG. 16C is a diagram illustrating an example of a display unit displayed by the extension application according to the fifth embodiment.

FIG. 17 is a sequence diagram illustrating a scanning processing operation according to the fifth embodiment.

FIG. 18 is a flowchart illustrating scanning processing that is performed by the extension application according to the fifth embodiment.

FIGS. 19A and 19B are a flowchart illustrating the scanning processing that is performed by the extension application according to the fifth embodiment.

FIG. 20 is a diagram illustrating an example of the display unit displayed by the extension application according to the fifth embodiment.

FIG. 21 is a sequence diagram illustrating another scanning processing operation according to the fifth embodiment.

FIG. 22 is a flowchart illustrating scanning processing that is performed by the extension application according to the fifth embodiment.

FIG. 23 is a sequence diagram illustrating a scanning operation according to the fifth embodiment.

FIG. 24 is a flowchart illustrating scanning processing that is performed by the extension application according to the fifth embodiment.

### DESCRIPTION OF THE EMBODIMENTS

Hereinafter, embodiments of the present disclosure will be described in detail with reference to the accompanying drawings. It should be noted that the following embodiments are not intended to limit the disclosure as defined in the claims, and not all combinations of features described in the embodiments are necessarily essential to the solution provided by the present disclosure.

### First Embodiment

### Hardware Configuration of Scanning System

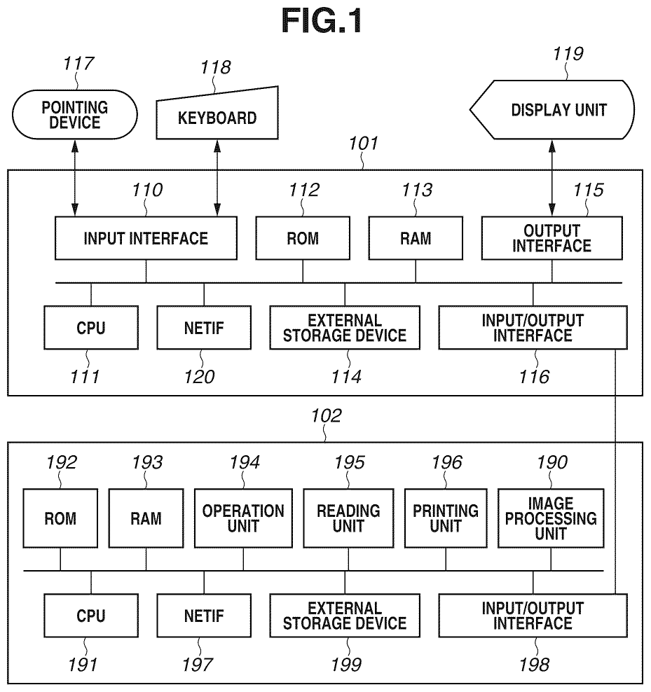

FIG. 1 is a block diagram illustrating a hardware configuration of a scanning system according to a first embodiment.

### Host Computer

A host computer 101 illustrated in FIG. 1 is an example of an information processing apparatus and includes an input interface 110, a central processing unit (CPU) 111, a read-only memory (ROM) 112, a random access memory (RAM) 113, an external storage device 114, an output interface 115, and an input/output interface 116. Various input devices, such as a keyboard 118 and a pointing device 117, are connected to the input interface 110. A display device, such as a display unit 119, is connected to the output interface 115. A network interface (NETIF) 120 controls data transfer between the host computer 101 and an external apparatus via a network.

The ROM 112 stores an initialization program.

The external storage device 114 is, for example, a hard disk drive (HDD) or a solid-state drive (SSD). The external storage device 114 stores an application program group, an operating system (OS), and various other data.

The RAM 113 is used as a working memory or the like in execution of various programs stored in the external storage device 114, and various programs can be operated in the host computer 101.

In the first embodiment, the CPU 111 performs processing based on program codes stored in the ROM 112, to execute functions to be described below in the host computer 101 and processing according to flowcharts to be described below.

### Scanning Device

A scanning device 102 serving as an example of a device is an example of an image processing apparatus and is connected to the host computer 101 via an input/output interface 198 of the scanning device 102 and the input/output interface 116 of the host computer 101. The input/output interface 198 of the scanning device 102 and the input/output interface 116 of the host computer 101 may be connected via a wired network or a wireless network.

The scanning device 102, which is an example of the image processing apparatus, includes a CPU 191, a ROM 192, a RAM 193, an operation unit 194, a reading unit 195, a printing unit 196, a NETIF 197, and the input/output interface 198.

The CPU 191 controls operations of the scanning device 102 in an integrated manner.

The ROM 192 is a memory that stores programs.

The RAM 193 is a memory that temporarily stores programs and image data.

The reading unit 195 is a scanner and reads an image of a document.

The printing unit 196 prints an image on a sheet based on image data. The printing unit 196 is optional.

The NETIF 197 is a network interface and controls data transfer between the scanning device 102 and an external apparatus via a network.

An image processing unit 190 performs various image editing operations on input image data.

In this configuration example, the host computer 101 and the scanning device 102 are separate from each other, but instead may be integrally formed as one information processing apparatus. A reading settings screen and an advanced setting screen to be described below are displayed on the display unit 119. The present embodiment illustrates an example where an electrophotographic digital multi-function peripheral including a plurality of functions, such as a copy function, a printing function, and a facsimile (FAX) function, is used as the scanning device 102. However, the scanning device 102 is not limited to this example. For example, the present embodiment is also applicable to an apparatus that uses any other processes, such as an inkjet printing process, and a scanner that performs only image reading processing. The host computer 101 may be, for example, a desktop personal computer, a smartphone, or a laptop computer.

### Software Configuration of Scanning System

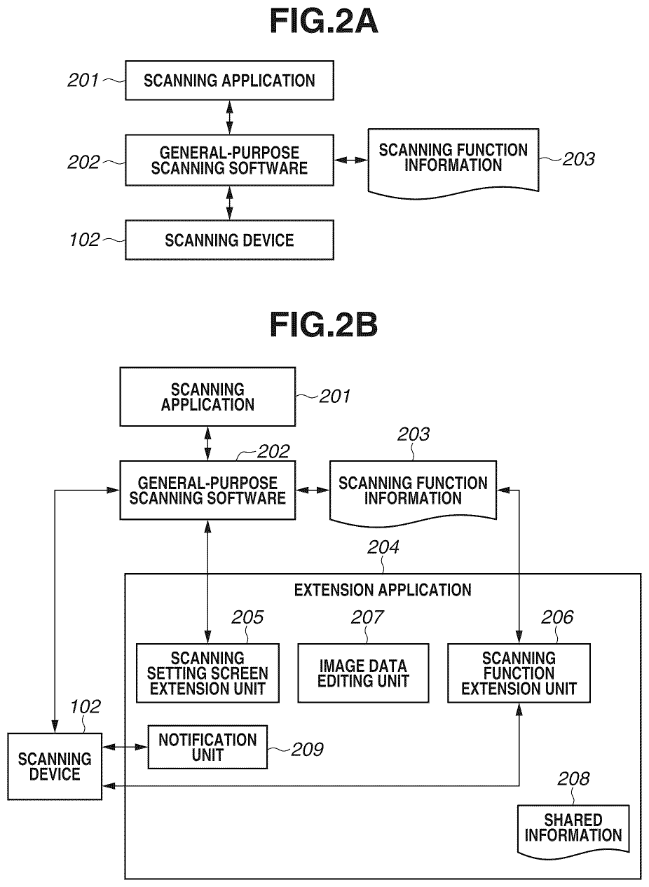

FIGS. 2A and 2B are block diagrams each schematically illustrating a software configuration of the scanning system. The software configuration illustrated in FIGS. 2A and 2B is stored in the external storage device 114 illustrated in FIG. 1. The present embodiment describes a case in which the scanning system uses the host computer 101 on which Microsoft® Windows® 11 is installed as the OS. This technology is also applicable to Apple MacOS to which a standard driver is also provided.

FIG. 2A illustrates a typical configuration example in which an extension application 204 is not associated with general-purpose scanning software 202 and the scanning device 102.

FIG. 2B illustrates a configuration example in which the extension application 204 is associated with the general-purpose scanning software 202 and the scanning device 102.

### Software Configuration of Scanning System (no Association With Extension Application

A configuration example of the scanning system in which the extension application 204 is not associated with each of the general-purpose scanning software 202 and the scanning device 102 is described with reference to FIG. 2A.

A scanning application 201 is software to load scanned content (image data). For example, the scanning application 201 corresponds to a document creation application or an image editing application. In response to receipt of a scanning request from a user, the scanning application 201 issues a scanning instruction to the OS. The scanning instruction includes scanning setting information to instruct operations of the general-purpose scanning software 202 and the scanning device 102.

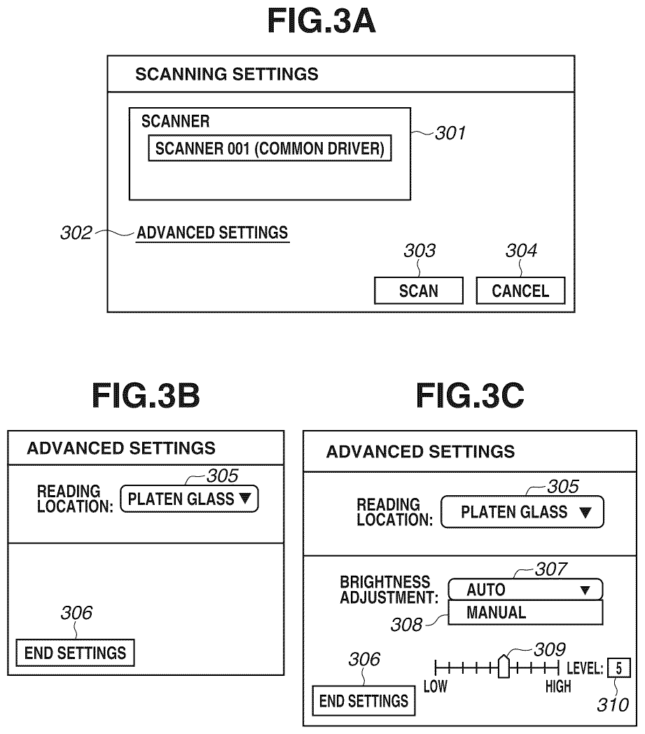

The scanning application 201 is configured to display a scanning setting screen provided by any of the general-purpose scanning software 202, the OS, and the scanning application 201 to execute the scanning instruction. In response to an advanced setting button for on the scanning setting screen being pressed, the general-purpose scanning software 202 additionally displays an advanced setting screen. The scanning setting screen and the advanced setting screen will be described below with reference to FIGS. 3A to 3C. The advanced setting screen includes setting items (hereinafter also referred to as “control items”) indicating settable scanning functions, and control items indicating setting values for the setting items, based on capability information (settable information) about the general-purpose scanning software 202.

The general-purpose scanning software 202 determines scanning capabilities based on scanning function information 203.

The scanning function information 203 is data indicating all settable scanning functions, setting values relating to the scanning functions, and an exclusive relationship between the setting values. The scanning function information 203 is included in a configuration file of the general-purpose scanning software 202 and is stored in the external storage device 114 as an unchangeable file. Alternatively, the scanning function information 203 may be dynamically generated by the general-purpose scanning software 202.

Specifically, the general-purpose scanning software 202 or the OS may be configured to obtain attribute data on the scanning device 102 from the scanning device 102 and generate the scanning function information 203 based on attribute information in the obtained attribute data. The general-purpose scanning software 202 uses an Internet Printing Protocol (IPP) to obtain the scanning function information 203 from the scanning device 102 and receive image data generated by scanning a document by the scanning device 102. In a case of dynamically generating the scanning function information 203, the generated scanning function information 203 is editable. The attribute data on the scanning device 102 obtained from the scanning device 102 includes attribute information indicating functions (capabilities of the scanning device) that can be designated in the scanning device 102 and setting values relating to the attribute information. This information is stored in the RAM 113.

With this configuration, the general-purpose scanning software 202 is configured to enable the user to designate scanning functions that can be used by each scanning device 102, in accordance with the connected scanning device 102. That is, even in a case of connecting scanning devices having different functions or connecting scanning devices developed by different vendors, the general-purpose scanning software 202 can be configured to enable the user to designate scanning functions that can be used, in accordance with the connected scanning device 102. The general-purpose scanning software 202 can also be configured to generate a scanning instruction that can be interpreted by a plurality of scanning devices manufactured by different vendors and to output the scanning instruction to the plurality of scanning devices manufactured by different vendors. The vendor may be a manufacturer of the scanning device 102. In the present embodiment, the general-purpose scanning software 202 is a standard class driver that executes scanning based on a standard scanning protocol called Mopria. The general-purpose scanning software 202 obtains capability information about the connected scanning device 102 so that the user can designate scanning functions supported by the connected scanning device 102, and generates the scanning function information 203 based on the capability information. However, the general-purpose scanning software 202 does not support a brightness adjustment function. This is because the brightness adjustment function is a function unique to the vendor (manufacturer) of each scanning device.

### Brightness Adjustment Function

The brightness adjustment function is a function for adjusting brightness of a read image. Scanning a document using this function allows the color of entire image data to be adjusted to brighter or darker, so that the user can obtain desired image data.

The brightness adjustment function enables the user to set an adjustment level. Further, an automatic setting is also available, and image data with suitable brightness can be automatically obtained.

While the first embodiment illustrates an example of a setting with a ten-level adjustment range, the setting for this function is not limited to this method. The setting range may be wider or narrower than this.

### Software Configuration of Scanning System (Association with Extension Application)

Next, a configuration example in which the extension application 204 is associated with each of the general-purpose scanning software 202 and the scanning device 102 is described with reference to FIG. 2B. The redundant descriptions of the same components that are illustrated in FIG. 2A are omitted.

The extension application 204 is software to extend or support the functions of the general-purpose scanning software 202, and is also called as a support application. The extension application 204 is software that is not included in the OS in advance (is not packaged with the OS).

Therefore, the user is required to download and install the extension application 204 from a server via the Internet by operating the host computer 101. Alternatively, the extension application 204 may be automatically installed based on the connection of the scanning device 102 to the host computer 101. Specifically, when the scanning device 102 is connected to the host computer 101, the OS obtains device identification information from the scanning device 102. The OS may download and install the extension application 204 corresponding to the obtained device identification information from the server via the Internet. In other words, the general-purpose scanning software 202 and the extension application 204 are stored in the host computer 101 as separate files.

The general-purpose scanning software 202 and the extension application 204 may be updated and upgraded. Update processing for the general-purpose scanning software 202 and update processing for the extension application 204 are performed at different timings. In other words, the timing of obtaining the general-purpose scanning software 202 by the host computer 101 is different from the timing of obtaining the extension application 204 by the host computer 101. A trigger for the host computer 101 to obtain the general-purpose scanning software 202 is also different from a trigger for the host computer 101 to obtain the extension application 204. When the extension application 204 is installed, the OS associates the extension application 204 with the general-purpose scanning software 202 and the scanning device 102.

The extension application 204 described in the present embodiment includes a scanning setting screen extension unit 205, a scanning function extension unit 206, an image data editing unit 207, and a notification unit 209. The extension application 204 also includes shared information 208 that can be commonly accessed from each unit. The actual content of the shared information 208 is a file stored in the external storage device 114, or information stored in the RAM 113. The extension application 204 uses an application program interface (API) provided by the OS to write and read information into and from the shared information 208.

The extension application 204 may end its operation each time the processing of each unit ends. In this case, the OS activates the extension application 204 every time the OS receives a request to use any one of the units.

Further, the extension application 204 may cancel processing every time the processing of each unit ends. In response to a cancellation of processing, a job being processed is deleted by the OS.

In response to receipt of a scanning request from the user, the scanning application 201 issues a scanning instruction to the OS. In this configuration, like in the configuration illustrated in FIG. 2A, the scanning application 201 can also display the scanning setting screen. In this configuration, the advanced setting screen provided by the extension application 204 is displayed. Specifically, the advanced setting screen provided by the scanning setting screen extension unit 205 included in the extension application 204 is displayed. The scanning setting screen extension unit 205 is configured to store advanced settings set by the user in the shared information 208.

The extension application 204 includes the image data editing unit 207. The image data editing unit 207 obtains image data from the scanning device 102 and edits the obtained image data. The image data editing unit 207 obtains advanced setting information from the shared information 208 and performs image editing processing on the image data based on the advanced settings. The extension application 204 may be configured to obtain image data obtained by the general-purpose scanning software 202 and perform image editing processing on the obtained image data based on the advanced settings.

Even with the configuration illustrated in FIG. 2B, there may be a case in which brightness adjustment processing is not performed by the user. In such a case, like the configuration illustrated in FIG. 2A, the general-purpose scanning software 202 may transmit a scanning request instruction to the scanning device 102 without passing through the extension application 204.

The extension application 204 includes the scanning function extension unit 206. The scanning function extension unit 206 is configured to edit the scanning function information 203 generated by the general-purpose scanning software 202 or the OS. This configuration enables the scanning function extension unit 206 to add functions provided by the extension application 204. The scanning function extension unit 206 is also configured to, for example, add functions (e.g., a brightness adjustment function) that are supported by the scanning device 102 and are not supported by the general-purpose scanning software 202, and add an exclusive relationship between setting values for the scanning functions. The OS activates the scanning function extension unit 206 when the extension application 204 has been first associated with the scanning device 102 and the general-purpose scanning software 202. Further, the OS may activate the scanning function extension unit 206 at any other timings, for example, when the OS is activated.

The extension application 204 includes the notification unit 209. The notification unit 209 is configured to display a notification for the user in response to an occurrence of an error in the scanning device 102 serving as an image processing apparatus. For example, in a case where a read paper jam error has occurred in the scanning device 102, the general-purpose scanning software 202 detects the occurrence of the error and the OS uses a notification function called a toast notification serving as a function of the OS to cause the display unit 119 to display a message. In response to the user pressing the toast notification, the notification unit 209 of the extension application 204 is invoked by the OS, and a user interface (UI) screen of the notification unit 209 is displayed. On the UI screen of the notification unit 209, for example, a message indicating details of a scanning paper jam error, or a paper jam release method may be displayed.

The configuration of the extension application 204 for implementing the present embodiment is not limited to the configuration including all the functions (units) described above, but instead may be a configuration including some of the functions, or a configuration including any other functions. The extension application 204 may also be simply referred to as scanning software.

As described above, the extension application 204 may include at least one of the following functions:
as a first function, a function (scanning setting screen extension unit 205) for displaying a setting screen,
as a second function, a function (image data editing unit 207) for editing image data based on advanced settings,
as a third function, a function (scanning function extension unit 206) for extending functions that can be designated by image data generation software, and
as a fourth function, a function (notification unit 209) for displaying a screen in response to an occurrence of an error in the scanning device 102.

### Scanning Setting Screen/Advanced Setting Screen

Examples of the scanning setting screen and the advanced setting screen according to the present embodiment are described with reference to FIGS. 3A to 3C. FIG. 3A is a diagram illustrating an example of the scanning setting screen displayed by the scanning application 201. FIG. 3B is a diagram illustrating an example of an advanced setting screen displayed in a configuration in which the extension application 204 illustrated in FIG. 2A is not included. FIG. 3C is a diagram illustrating an example of another advanced setting screen displayed in a configuration in which the extension application 204 illustrated in FIG. 2B is included.

The unit or module for displaying the scanning setting screen is not limited to the above-described example. For example, the scanning setting screen extension unit 205 may be configured to generate only a display screen. In this case, the scanning setting screen extension unit 205 transmits the generated display screen to the scanning application 201 via the general-purpose scanning software 202. The scanning application 201 may be configured to display the display screen obtained via the general-purpose scanning software 202.

### Scanning Setting Screen (Scanning Application)

First, a scanning setting screen that is displayed by the scanning application 201 illustrated in FIG. 3A is described.

A control item 301 includes objects that allow the user to set a scanner (scanner to be used for reading) to be used for scanning image data.

A control item 302 is an advanced settings button. In response to the control item 302 being pressed, an additional scanning screen is displayed by the general-purpose scanning software 202 or the scanning setting screen extension unit 205.

A control item 303 is a scanning start button, and a control item 304 is a scanning cancel button.

### Advanced Setting Screen (General-Purpose Scanning Software)

Next, an additional settings screen illustrated in FIG. 3B that is displayed by the general-purpose scanning software 202 in a case where the extension application 204 is not included is described.

A control item 305 is an item for setting a reading location, and in the illustrated case, the control item 305 indicates that “PLATEN GLASS”is selected.

A control item 306 is a setting end button. In response to the control item 306 being pressed, the screen returns to the scanning setting screen illustrated in FIG. 3A.

### Advanced Setting Screen (Scanning Setting Screen Extension Unit)

Next, FIG. 3C is described. FIG. 3C illustrates another additional setting screen that is displayed by the scanning setting screen extension unit 205 in a case where the extension application 204 is included. Differences from the screen illustrated in FIG. 3B are that a control item 307, a list 308, a control item 309, and a control item 310 are added.

The control item 307 is a button to select a brightness adjustment setting, and in the illustrated case, the control item 307 indicates that “AUTO”is selected.

The list 308 indicates brightness adjustment setting items in response to the control item 307 being pressed. FIG. 3C indicates that the list 308 has “AUTO” which is currently selected, as well as “MANUAL”. The setting item “AUTO” is an item for automatically setting brightness adjustment, and brightness adjustment processing can be automatically performed in accordance with a scanned image. The setting item “MANUAL” is an item for the user to manually set brightness adjustment, and the brightness of a scanned image is adjusted by moving a bar corresponding to the control item 309 to the left or right.

The control item 310 indicates a brightness level set by the user in a case where “MANUAL” is selected on the list 308. In the following embodiments, an operation that is performed in a case where “AUTO” is selected on the list 308 is described. An operation to be performed in a case where “MANUAL” is selected and the brightness level is set by the user is also similar to the case in which “AUTO”is selected.

While the present embodiment illustrates a configuration example in which settings are set using a bar in a manual mode, numerical values may be directly input, or a button or the like may be used to select numerical values to be input. A configuration in which icons and the like indicating brightness levels are displayed and selected may also be applicable.

The reason why the scanning setting items are different between FIGS. 3B and 3C is described. The advanced setting screen is generated with reference to scanning capability information that has been generated based on the scanning function information 203.

However, since the general-purpose scanning software 202 does not support the brightness adjustment function, the general-purpose scanning software 202 is unable to add the brightness adjustment function to the scanning function information 203. Even in a case where the scanning function information 203 has originally included the brightness adjustment function, the general-purpose scanning software 202 is unable to interpret the brightness adjustment function included in the scanning function information 203. Consequently, the brightness adjustment setting is unable to be displayed on the advanced setting screen. However, the scanning function extension unit 206 is configured to add the brightness adjustment function to the scanning function information 203, and the scanning setting screen extension unit 205 is configured to display the advanced setting screen with reference to scanning capabilities. With these configurations, the extension application 204 can display the brightness adjustment setting on the advanced setting screen. FIG. 3C may also include an additional extended function other than the brightness adjustment function.

### Scanning Function Information Editing Processing: Scanning Function Extension Unit

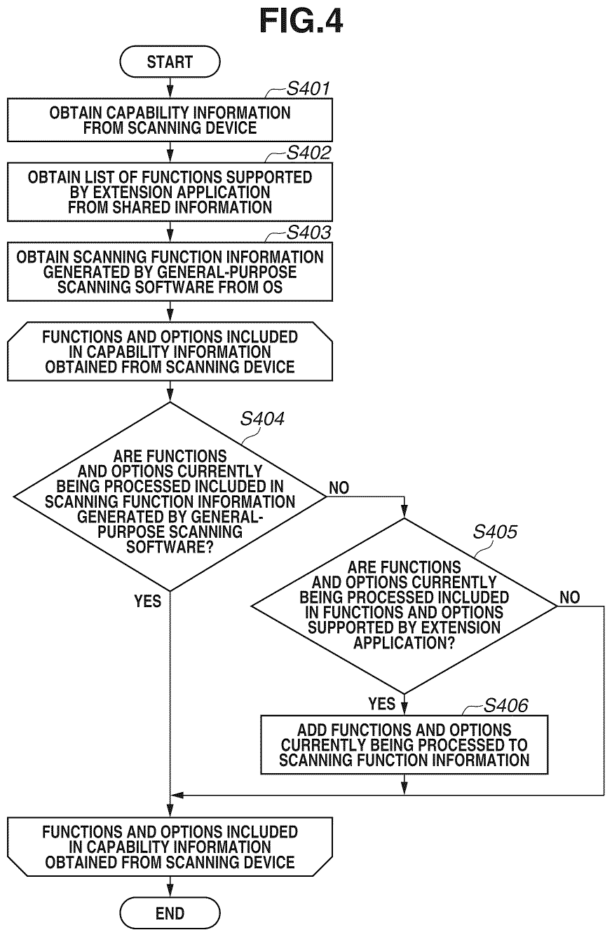

A processing procedure for the scanning function extension unit 206 to edit the scanning function information 203 is described with reference to FIG. 4. Each step is implemented by the CPU 111 executing each unit which is a program loaded from the external storage device 114 into the RAM 113.

In step S401, the scanning function extension unit 206 obtains capability information from the scanning device 102. The capability information includes attribute information indicating functions that can be designated in the scanning device 102, and setting values related to the attribute information.

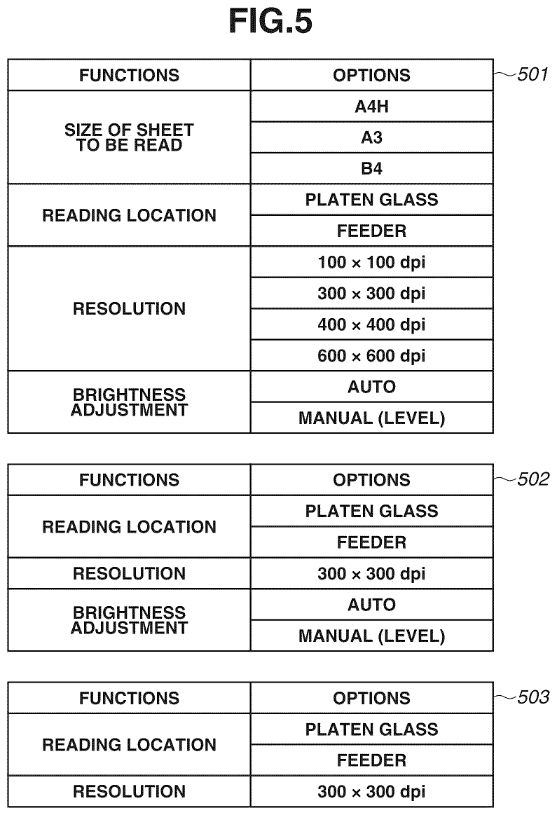

A table 501 illustrated in FIG. 5 is an example of a list of capability information obtained from the scanning device 102. As illustrated in the table 501, functions, such as a reading size designation function, and options that can be set for each function can be obtained from the scanning device 102.

In step S402, the scanning function extension unit 206 obtains a list of scanning functions supported by the extension application 204 from the shared information 208. The list of scanning functions supported by the extension application 204 is stored in the shared information 208. In the scanning function list, all scanning functions that can be processed by the extension application 204 and setting values for the scanning functions are described. A table 502 illustrated in FIG. 5 is an example of a list of scanning functions that are supported by the extension application 204. The list of scanning functions supported by the extension application 204 may be updated by, for example, upgrading the extension application 204.

In step S403, the scanning function extension unit 206 obtains the scanning function information 203 created by the general-purpose scanning software 202 from the OS. A table 503 illustrated in FIG. 5 is an example of a list of scanning functions supported by the general-purpose scanning software 202. The scanning function information 203 is created by the general-purpose scanning software 202 based on capability information (Table 501 illustrated in FIG. 5) obtained by the general-purpose scanning software 202 from the scanning device 102. Only the scanning functions supported by the general-purpose scanning software 202 in the capability information obtained from the scanning device 102 are described in the scanning function information 203 created by the general-purpose scanning software 202, so that the functions in the scanning function information 203 are limited. For example, the capability information (table 501 illustrated in FIG. 5) obtained from the scanning device 102 includes the brightness adjustment function. However, the general-purpose scanning software 202 does not support the brightness adjustment function, and the brightness adjustment function is not described in the scanning function information 203. The scanning function extension unit 206 adds functions and options to the scanning function information 203, whereby the extension application 204 can compensate for the lack of functions of the general-purpose scanning software 202. The scanning function extension unit 206 may also delete unnecessary functions and options from the scanning function information 203 created by the general-purpose scanning software 202.

Subsequent steps S404, S405, and S406 are processing to be repeatedly performed on the list of functions included in the capability information obtained from the scanning device 102 in step S401. In the present embodiment, the processing to be repeatedly performed is for eleven options from “reading size: A4H” to “brightness adjustment: manual (level)”included in the table 501.

In step S404, the scanning function extension unit 206 determines whether functions and options currently being processed are included in the scanning function information 203 generated by the general-purpose scanning software 202. In a case where functions and options currently being processed are included in the scanning function information 203 (YES in step S404), the processing returns to the top of the loop. Specifically, the next item is selected from among the functions and options included in the scanning function information 203 obtained from the scanning device 102 and the processing of step S404 is performed again. In a case where the last item is currently being processed among the functions and options included in the capability information obtained from the scanning device 102, the loop is finished and the processing in the flowchart illustrated in FIG. 4 ends. In a case where functions and options currently being processed are not included in the scanning function information 203 (NO in step S404), the processing proceeds to step S405. In the present embodiment, for example, an item “reading location: platen glass” included in the table 501 indicating scanning functions of the scanning device 102 is also included in the table 503 indicating the scanning functions of the general-purpose scanning software 202. Thus, in this case, the determination result is “YES” in step S404. On the other hand, because an item “reading size: A4H” included in the table 501 is not included in the table 503, the determination result is “NO” and the processing proceeds to step S405.

In step S405, the scanning function extension unit 206 determines whether functions and options currently being processed are included in the functions and options supported by the extension application 204. In a case where the scanning function extension unit 206 determines that functions and options currently being processed are included in the supported functions and options (YES in step S405), the processing proceeds to step S406. In a case where the scanning function extension unit 206 determines that functions and options currently being processed are not included in the supported functions and options (NO in step S405), like in the case where the determination result is “YES” in step S404, the processing returns to step S404, or the processing illustrated in FIG. 4 ends. In the present embodiment, for example, when the currently-processed function is “brightness adjustment: auto”, this function is also included in the table 502 as capability information about the extension application 204, and thus, in this case, the determination result in step S405 is “YES” and the processing proceeds to step S406.

In step S406, the scanning function extension unit 206 adds functions and options currently being processed to the scanning function information 203. After the processing of step S406, like in the case where the determination result in step S404 is “YES”, the processing of step S404 is performed again, or the processing illustrated in FIG. 4 ends.

As described above, the scanning function extension unit 206 adds functions and options that are not supported by the general-purpose scanning software 202 and are supported by each of the scanning device 102 and the extension application 204 to the scanning function information 203. Based on the scanning function information edited by the above described processing, the scanning capability information is generated. Further, the scanning setting screen extension unit 205 is configured to generate a display screen based on the generated scanning capability information, whereby the advanced setting screen illustrated in FIG. 3C can be displayed with extended functions that are not supported by the general-purpose scanning software 202.

### Scanning Processing Sequence

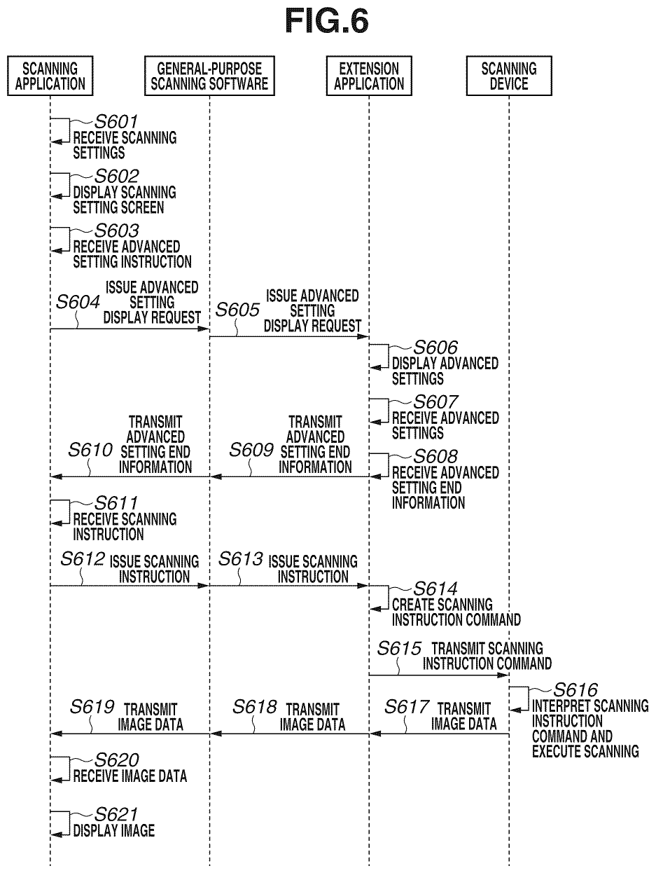

Next, a processing sequence for the scanning application 201, the general-purpose scanning software 202, the extension application 204, and the scanning device 102 after the scanning application 201 has received scanning settings is described with reference to FIG. 6. Steps other than the steps for the scanning device 102 illustrated in FIG. 6 are carried out by the CPU 111 loading the scanning application 201, the general-purpose scanning software 202, and the extension application 204 into the RAM 113 from the external storage device 114 and executing these applications. Each step for the scanning device 102 illustrated in FIG. 6 is implemented by the CPU 191 of the scanning device 102 loading programs stored in the ROM 192 or an external storage device 199 into the RAM 193 and executing the programs.

In step S601, the scanning application 201 receives scanning settings set by the user.

The user can issue a scanning setting instruction to the scanning application 201 by operating the pointing device 117 and the keyboard 118.

In step S602, the scanning application 201 displays the scanning setting screen illustrated in FIG. 3A on the display unit 119.

In step S603, the scanning application 201 receives an advanced setting instruction. The user can issue the advanced setting instruction by operating the pointing device 117 and the keyboard 118 to select the control item 302.

In step S604, the scanning application 201 issues an advanced setting display request to the general-purpose scanning software 202.

In step S605, the general-purpose scanning software 202 issues the advanced setting display request to the extension application 204. As described above, in the configuration illustrated in FIG. 2B, the general-purpose scanning software 202 displays the advanced setting screen illustrated in FIG. 3C.

In step S606, the scanning setting screen extension unit 205 of the extension application 204 causes the display unit 119 to display the advanced setting screen illustrated in FIG. 3C. As described above with reference to FIG. 4, this is because the brightness adjustment setting is added to the scanning function information 203 by the scanning function extension unit 206. The scanning setting screen extension unit 205 causes the display unit 119 to display the advanced setting screen illustrated in FIG. 3C with reference to the scanning capability information generated based on the scanning function information 203 to which the brightness adjustment setting has been added. In the present embodiment, the extension application 204 supports one resolution option, that is, 300×300 dots per inch (dpi). Therefore, there is no need to cause the user to select a resolution, and thus resolution options are not displayed on the advanced setting screen. Even in a case where selection of a resolution is unavailable, resolution options may be displayed on the advanced setting screen and may be presented to the user.

In step S607, the scanning setting screen extension unit 205 receives advanced settings. In the present embodiment, as illustrated in FIG. 3C, a description is given of a case in which “reading location: platen glass” and “brightness adjustment: auto” are selected by the user. The CPU 111 stores the received settings in the RAM 113.

In step S608, the scanning setting screen extension unit 205 receives information indicating that advanced settings are ended, and issues an instruction to write the received settings into the scanning setting information. The user can issue an advanced setting end instruction by operating the pointing device 117 and the keyboard 118 to select the control item 306. In a case of writing the received settings into the scanning setting information, items such as “resolution”that are not to be selected by the user may also be written.

In step S609, the extension application 204 transmits information indicating that the advanced settings are ended to the general-purpose scanning software 202.

In step S610, the general-purpose scanning software 202 transmits the information indicating that the advanced settings are ended to the scanning application 201.

In step S611, the scanning application 201 receives a scanning instruction. The user can issue the scanning instruction by operating the pointing device 117 and the keyboard 118 to select the control item 303.

In step S612, the scanning application 201 issues the scanning instruction to the general-purpose scanning software 202.

In step S613, the general-purpose scanning software 202 issues the scanning instruction to the extension application 204.

In step S614, the extension application 204 creates a scanning instruction command based on scanning setting information written in step S608. In step S608, if items such as “resolution” that are not to be selected by the user are not written into the scanning setting information, the extension application 204 may add the items during creation of the scanning instruction command in step S614. Instead of adding the items, the scanning device 102 may be operated based on default values.

In step S615, the extension application 204 transmits the scanning instruction command to the scanning device 102 to issue the scanning instruction.

In step S616, the scanning device 102 interprets the scanning instruction command and executes scanning.

During execution of scanning, necessary image processing in accordance with the scanning instruction is performed on image data.

In the present embodiment, in a case where the scanning settings as illustrated in FIG. 3C are set, the image processing unit 190 performs brightness adjustment processing on image data obtained by scanning as described below. The reading unit 195 may be configured to perform a reading operation while adjusting the brightness. In any case, image data is generated by adjusting the brightness to a designated brightness level. In other words, image data with brightness adjusted to a designated brightness level is generated.

In step S617, the scanning device 102 transmits the generated image data to the extension application 204.

In step S618, the extension application 204 transmits the received image data to the general-purpose scanning software 202.

In step S619, the general-purpose scanning software 202 transmits the received image data to the scanning application 201.

In step S620, the scanning application 201 receives the image data.

In step S621, the scanning application 201 displays the received image data.

### Scanning Processing: Extension Application

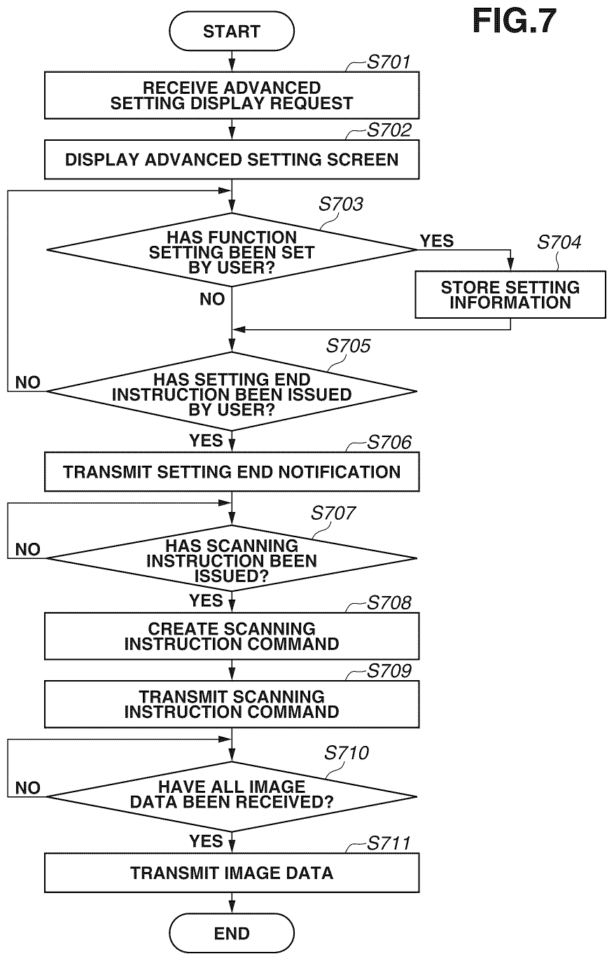

A procedure of scanning processing that is executed by the extension application 204 is described with reference to FIG. 7. Each step is implemented by the CPU 111 executing each unit which is a program loaded into the RAM 113 from the external storage device 114.

In step S701, the extension application 204 receives an advanced setting display request.

In step S702, the scanning setting screen extension unit 205 of the extension application 204 causes the display unit 119 to display the advanced setting screen illustrated in FIG. 3C. As described above with reference to FIG. 4, this is because the brightness adjustment setting has been added to the scanning function information 203 by the scanning function extension unit 206. The scanning setting screen extension unit 205 causes the display unit 119 to display the advanced setting screen illustrated in FIG. 3C with reference to the scanning capability information generated based on the scanning function information 203 to which the brightness adjustment setting has been added.

In step S703, the scanning setting screen extension unit 205 determines whether a function setting has been set by the user. In a case where the scanning setting screen extension unit 205 determines that a function setting has been set by the user (YES in step S703), the processing proceeds to step S704. In a case where the scanning setting screen extension unit 205 determines that no function setting has been set by the user (NO in step S703), the processing proceeds to step S705.

In step S704, the CPU 111 receives advanced settings and stores the received settings in the RAM 113. Then, the processing proceeds to step S705.

In step S705, the scanning setting screen extension unit 205 determines whether a setting end instruction has been issued by the user. In a case where the scanning setting screen extension unit 205 determines that the setting end instruction has been issued (YES in step S705), the CPU 111 receives information indicating that the advanced settings are ended and writes the received settings into the scanning setting information. Then, the processing proceeds to step S706. In a case where the scanning setting screen extension unit 205 determines that the setting end instruction is not issued (NO in step S705), the processing returns to step S703, and the CPU 111 determines whether a function setting is set by the user again.

In step S706, the extension application 204 transmits an advanced setting end notification received from the CPU 111 to the general-purpose scanning software 202.

In step S707, the extension application 204 determines whether a scanning instruction is issued from the general-purpose scanning software 202. In a case where the extension application 204 determines that the scanning instruction has been issued (YES in step S707), the processing proceeds to step S708. In a case where the extension application 204 determines that the scanning instruction has not been issued (NO in step S707), the processing returns to step S707, and determination of whether the scanning instruction has been issued from the general-purpose scanning software 202 is performed.

In step S708, the extension application 204 creates a scanning instruction command based on the scanning setting information written in step S705.

Examples of a method for creating the scanning instruction command in step S708 include a method of extending commands in a standard protocol. Examples of a method for extending commands include a method of describing a dedicated command in a command extension region in the standard protocol. Other examples of the extension method include a method of adding a command of a particular standard to the end of a command to be used in the standard protocol, and a method in which a command to be used in the standard protocol is replaced by a proprietary command system by the extension application 204.

In a case of issuing an instruction from the extension application 204, the instruction may be issued and communication may be established using a protocol unique to the vendor regardless of the standard protocol.

In step S709, the extension application 204 transmits a scanning instruction command to the scanning device 102 to issue a scanning instruction.

In step S710, the extension application 204 determines whether all image data have been received from the scanning device 102. In a case where the extension application 204 determines that all image data have been received (YES in step S710), the processing proceeds to step S711. In a case where the extension application 204 determines that not all image data have been received (NO in step S710), the processing returns to step S710 to determine whether all image data have been received from the scanning device 102.

In step S711, the extension application 204 transmits the received image data to the general-purpose scanning software 202, and then this processing ends.

### Scanning Processing: Scanning Device

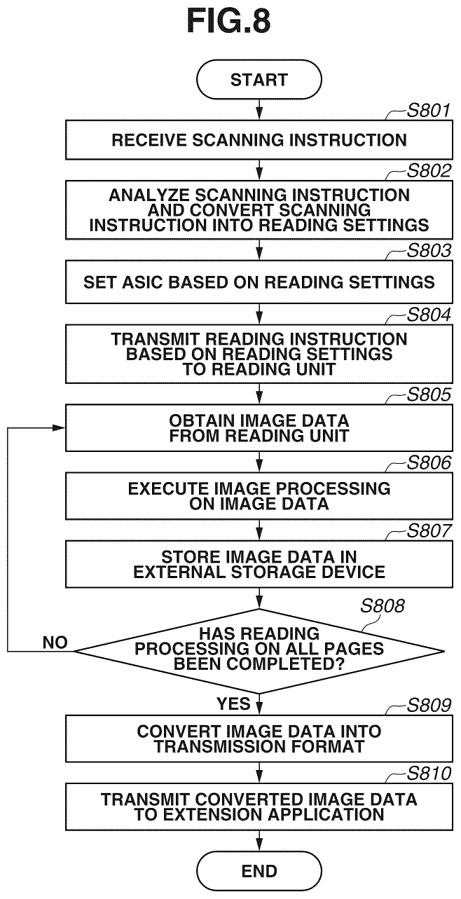

A procedure of scanning processing that is performed by the scanning device 102 that has received the scanning instruction from the extension application 204 is described with reference to FIG. 8. Each step illustrated in the flowchart of FIG. 8 is implemented by the CPU 191 executing programs stored in the ROM 192.

In step S801, the CPU 191 receives a scanning instruction transmitted from the extension application 204.

In step S802, the scanning instruction command received in the previous step S801 is analyzed and converted into reading settings based on which reading processing can be performed by the scanning device 102. In the present embodiment, reading settings are set with “reading location: platen glass”, “brightness adjustment: auto”, and “resolution: 300×300 dpi”.

In step S803, the CPU 191 determines an application-specific integrated circuit (ASIC) for the image processing unit 190 to be used to execute scanning based on the reading settings converted in step S802, and performs settings for the ASIC.

In step S804, the CPU 191 transmits a reading instruction based on the reading settings to the reading unit 195. In the present embodiment, an instruction to perform a reading operation on the platen glass is transmitted.

In step S805, the CPU 191 obtains image data from the reading unit 195.

In step S806, the CPU 191 and the image processing unit 190 execute image processing on the received image data.

In the present embodiment, processing of converting the resolution to “300×300 dpi” and brightness adjustment processing are performed. In the brightness adjustment processing, the ASIC set in step S803 is used to analyze the image data and automatically adjust the brightness to a suitable brightness level. In a case where the reading unit 195 is capable of performing a reading operation with a resolution of 300×300 dpi, the reading unit 195 may obtain image data with a resolution of 300×300 dpi and image processing may be omitted in step S806. While, in the present embodiment, the image processing unit 190 performs brightness adjustment processing, the reading unit 195 may be configured to perform a reading operation while adjusting the brightness.

In step S807, the CPU 191 stores the image data in the external storage device 199.

In step S808, the CPU 191 determines whether scanning processing on all pages has been completed. In a case where the CPU 191 determines that the scanning processing has not been completed (NO in step S808), the processing returns to step S805 to execute scanning processing on the next page. In a case where the CPU 191 determines that the scanning processing has been completed (YES in step S808), the processing proceeds to step S809.

In step S809, the CPU 191 and the image processing unit 190 convert the image data stored in the previous step S807 in accordance with a transmission format setting received in the previous step S801. In the present embodiment, the transmission format is not included in the scanning instruction received from the extension application 204. Thus, while the image data is converted into a default transmission format of the scanning device 102, that is, a Joint Photographic Experts Group (JPEG) format, the transmission format to be converted is not limited to this format, and any other format that can be handled by the information processing apparatus may be used.

In step S810, the converted image data is transmitted to the extension application 204, and then the entire processing ends.

As described above, in the present embodiment, the scanning setting screen extension unit 205 of the extension application 204 modifies the scanning function information 203 based on the capability information about each of the general-purpose scanning software 202, the extension application 204, and the scanning device 102. Further, in a case where an advanced setting screen request is issued from the user, the settings screen is displayed based on the scanning capability information generated from the scanning function information 203, whereby the user can perform brightness adjustment processing. After that, in response to receipt of the scanning instruction in which the brightness adjustment setting has been reflected, the scanning device 102 performs reading processing to generate image data of which brightness has been adjusted to a designated brightness level. A series of processing described above enables the scanning device 102 to implement the brightness adjustment function, whereby the brightness adjustment function can be provided to the user.

While the present embodiment illustrates a configuration example using the advanced setting screen illustrated in FIG. 3C in the configuration illustrated in FIG. 2B, the present disclosure is not limited to this configuration. For example, in a case where the advanced setting display request is issued to the general-purpose scanning software 202 in step S604, the general-purpose scanning software 202 may display the advanced setting screen illustrated in FIG. 3B. Next, after the advanced settings illustrated in FIG. 3B are set, the general-purpose scanning software 202 issues an additional advanced setting screen display request to the extension application 204. Then, the extension application 204 may display an additional advanced setting screen on which the brightness adjustment setting can be set.

While the scanning instruction is issued to the extension application 204 from the general-purpose scanning software 202, the method of issuing the scanning instruction is not limited to this example. For example, the instruction may be issued from the scanning application 201 to the extension application 204, or a scanning instruction control item may be disposed on the advanced setting screen so that the user can directly instruct the extension application 204. As a method of transmitting image data, image data may be directly transmitted from the extension application 204 to the scanning application 201 without involving the general-purpose scanning software 202, or may be transmitted from the scanning device 102 to the scanning application 201. The received image data may be stored in the external storage device 114 and only information about a file path may be transmitted as a storage location.

While, in the present embodiment, in a case where there is a plurality of pieces of image data, all the image data are received and then transferred, the transmitted image data may be transferred as needed.

### Second Embodiment

A second embodiment of the present disclosure will be described below. In the first embodiment described above, the scanning device 102 first interprets the scanning setting information including the brightness adjustment setting, and then the scanning device 102 performs scanning processing based on the designated brightness adjustment setting.

However, some scanning devices are unable to perform brightness adjustment processing. In this case, even if the brightness adjustment function is supported by the extension application 204 and scanning setting information including the designated brightness adjustment setting can be generated, such scanning devices are unable to perform brightness adjustment processing.

Thus, in the second embodiment, first, determination of whether brightness adjustment processing can be performed based on capability information about a scanning device is performed. In a case where the scanning device is capable of performing brightness adjustment processing, scanning setting information including the brightness adjustment setting designated by the user is generated and the generated scanning setting information is transmitted to the scanning device. On the other hand, in a case where the scanning device is not capable of performing brightness adjustment processing, scanning setting information including no brightness adjustment setting is generated and the generated scanning setting information is transmitted to the scanning device. After that, an extension application performs brightness adjustment processing on image data read by the scanning device. Thus, even in a case where the scanning device is not able to perform brightness adjustment processing, image data of which brightness has been adjusted to a desired brightness level can be provided to the user.

Differences from the first embodiment will be described below.

A description is given of a case in which the scanning device 102 is a scanning device not supporting a brightness adjustment function. The configuration of the extension application 204 according to the second embodiment differs from the configuration of the extension application 204 according to the first embodiment. Even in a case where the brightness adjustment function is not included in the capability information obtained from the scanning device 102, the scanning function extension unit 206 adds a brightness adjustment designation to the scanning function information 203 when the extension application 204 includes a unit for performing the adjustment processing on image data. The image data editing unit 207 performs brightness adjustment processing on the image data received from the scanning device 102, based on the brightness setting in a brightness adjustment designation function set by the user. This processing will be described in detail below.

### Scanning Function Information Editing Processing: Scanning Function Extension Unit

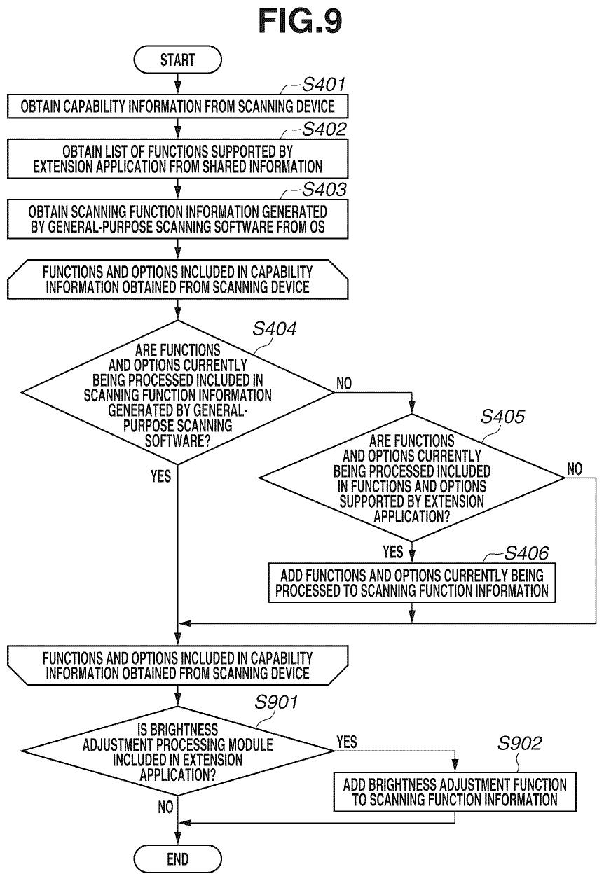

Scanning function information editing processing that is performed by the scanning function extension unit 206 according to the second embodiment is described with reference to FIG. 9. In FIG. 9, same step numbers are used to designate the same steps in FIG. 4, and the redundant descriptions are omitted. Differences between FIG. 9 and FIG. 4 are mainly described. Each step illustrated in FIG. 9 is implemented by the CPU 111 executing each unit which is a program loaded into the RAM 113 from the external storage device 114.

The scanning function extension unit 206 repeatedly performs the processing of steps S404 to S406, and then the processing proceeds to step S901. In this case, the scanning device 102 does not support the brightness adjustment function. Consequently, the brightness adjustment function is not added to the scanning function information 203 obtained after the processing of steps S404 to S406 ends.

Thus, in steps S901 and S902, processing of adding the function to the scanning function information 203 is performed in accordance with a module that is not included in the capability information returned from the scanning device 102 but is included in the extension application 204.

Specifically, in step S901, the scanning function extension unit 206 determines whether a module for performing brightness adjustment processing is included in the extension application 204, with reference to the capability information (Table 501 illustrated in FIG. 5) about the scanning device 102 and the scanning function information 203. In a case where the scanning function extension unit 206 determines that the module for brightness adjustment processing is included (YES in step S901), the processing proceeds to step S902. In a case where the scanning function extension unit 206 determines that the module is not included (NO in step S901), this processing ends. In the second embodiment, the image data editing unit 207 is capable of performing brightness adjustment processing, and thus the scanning function extension unit 206 determines that the extension application 204 includes the module for brightness adjustment processing.

In step S902, the scanning function extension unit 206 adds the brightness adjustment function to the scanning function information 203, and then this processing ends.

As described above, first, the scanning function extension unit 206 adds functions and options that are not supported by the general-purpose scanning software 202, and functions and options that are supported by the scanning device 102 and the extension application 204 to the scanning function information 203. After that, the scanning function extension unit 206 performs determination of whether the extension application 204 is capable of performing brightness adjustment processing. In a case where the extension application 204 is capable of performing brightness adjustment processing, the brightness adjustment function is added to the scanning function information 203. This processing enables the scanning setting screen extension unit 205 to generate a display screen based on the scanning function information 203, whereby the advanced setting screen illustrated in FIG. 3C can be displayed even in a case where the brightness adjustment function is not supported by the scanning device 102.

### Scanning Processing Sequence

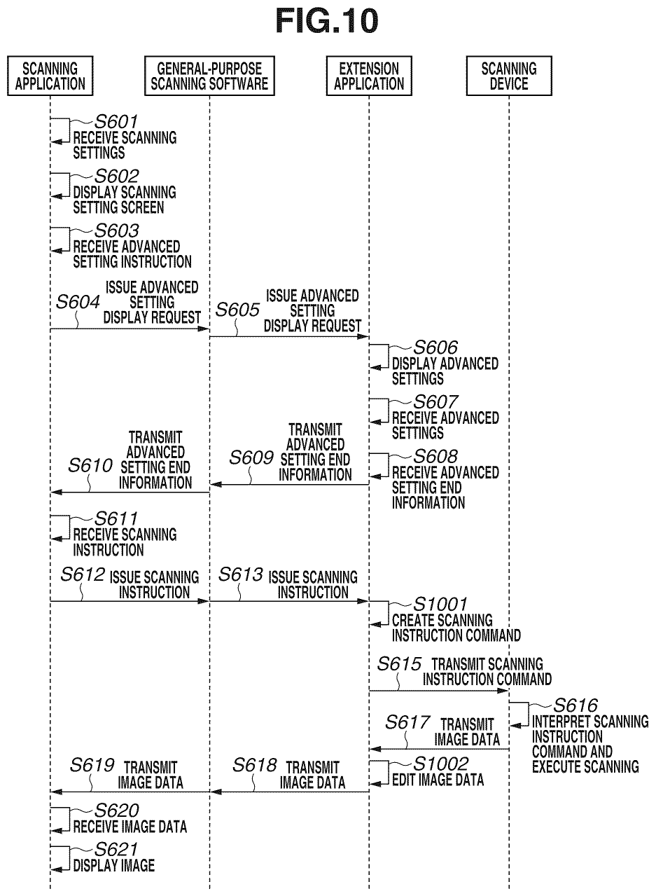

Next, a processing sequence for the scanning application 201, the general-purpose scanning software 202, the extension application 204, and the scanning device 102 after the scanning application 201 has received scanning settings is described with reference to FIG. 10. Steps other than the steps for the scanning device 102 illustrated in FIG. 10 are carried out by the CPU 111 loading the scanning application 201, the general-purpose scanning software 202, and the extension application 204 into the RAM 113 from the external storage device 114 and executing these applications. Each step for the scanning device 102 illustrated in FIG. 10 is implemented by the CPU 191 of the scanning device 102 loading programs stored in the ROM 192 or the external storage device 199 into the RAM 193 and executing the programs. In FIG. 10, same step numbers are used to designate the same steps in FIG. 6, and the redundant descriptions are omitted. Differences between FIG. 10 and FIG. 6 are mainly described.

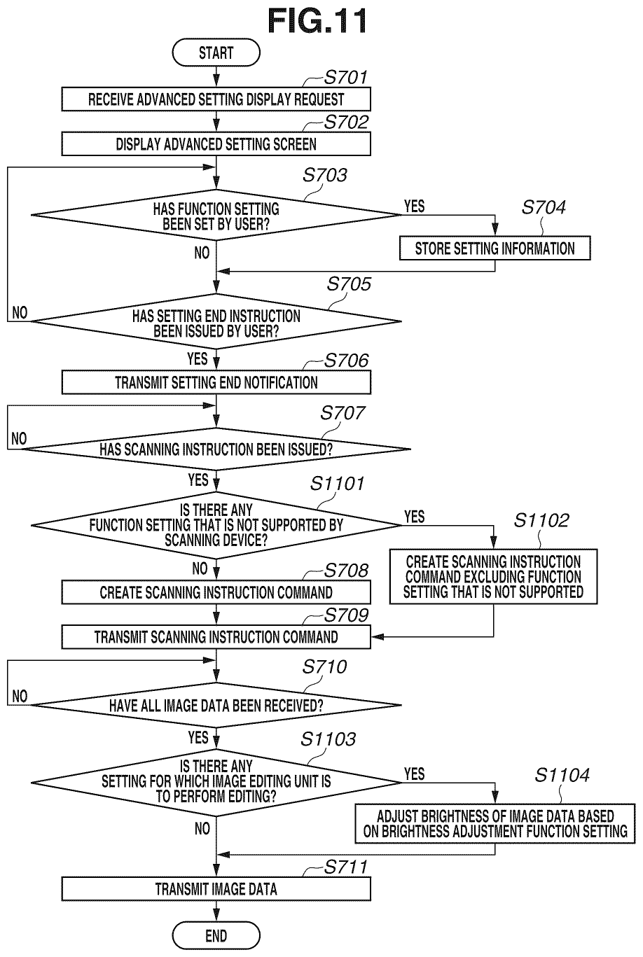

In step S1001, the extension application 204 creates a reading instruction command. A detailed operation in this processing is described with reference to a flowchart illustrated in FIG. 11.

In step S1002, the image data editing unit 207 performs brightness adjustment processing on the received image data. In the present embodiment, the brightness of image data is automatically adjusted to an optimum brightness level.

A procedure of scanning processing that is executed by the extension application 204 is described with reference to FIG. 11. In FIG. 11, same step numbers are used to designate the same steps in FIG. 7, and the redundant descriptions are omitted. Differences between FIG. 11 and FIG. 7 are mainly described. Each step is implemented by the CPU 111 executing each unit which is a program loaded into the RAM 113 from the external storage device 114.

### Scanning Processing: Extension Application

In step S1101, the extension application 204 obtains capability information about the scanning device 102 from the shared information 208. If the capability information about the scanning device 102 is not included, the scanning function extension unit 206 may issue a capability information request to the scanning device 102 and may store the capability information in the shared information 208.

The extension application 204 determines whether there is any function setting that is not supported by the scanning device 102, based on the obtained capability information and setting information. In a case where the extension application 204 determines that a function setting that is not supported by the scanning device 102 is set (YES in step S1101), the processing proceeds to step S1102. In the second embodiment, the brightness adjustment function that is not supported by the scanning device 102 is set, and thus the processing proceeds to step S1102. In a case where the extension application 204 determines that the function that is not supported by the scanning device 102 is not set (NO in step S1101), the processing proceeds to step S708.

In step S1102, the extension application 204 excludes the function setting that is not supported, and creates a scanning instruction command. In the present embodiment, the brightness adjustment function is not included in the scanning instruction command. Then, the processing proceeds to step S709.

Next, processing that is performed in a case where it is determined that the image data has been received in step S710 is described.

In step S1103, the extension application 204 determines whether there is any setting for which the image data editing unit 207 is to perform editing, based on the setting information. In a case where the extension application 204 determines that there is any setting for which editing is to be performed (YES in step S1103), the processing proceeds to step S1104. In the second embodiment, since the brightness adjustment function that is unable to be executed by the scanning device 102 is set, the processing proceeds to step S1104. On the other hand, in a case where the extension application 204 determines that there is no setting for which editing is to be performed (NO in step S1103), the processing proceeds to step S711.

In step S1104, the image data editing unit 207 adjusts the brightness of the received image data to an optimum brightness level based on the brightness adjustment function setting set in step S703, and then the processing proceeds to step S711.

In the present embodiment, the function setting that is not supported by the scanning device 102 is excluded from the scanning instruction command. However, even in a case where the function setting is described in the scanning instruction command, the scanning device 102 is unable to interpret the instruction command including the function setting that is not supported, and consequently, unable to execute the function.

Thus, the function that is not supported may be described as it is without being excluded from the scanning instruction command.

As described above, according to the second embodiment, the brightness adjustment function is provided to the user even when the brightness adjustment function is not supported by the scanning device 102.

### Third Embodiment

A third embodiment of the present disclosure will be described below. The first and second embodiments described above illustrate a configuration example in which the extension application 204 and the scanning device 102 exchange information.

The third embodiment illustrates a configuration example in which the scanning device 102 exchanges information with the general-purpose scanning software 202 and the extension application 204 performs only scanning command extension processing and image editing processing.

Differences from the first and second embodiments will be described below.

### Scanning Processing Sequence (Extension of Commands)

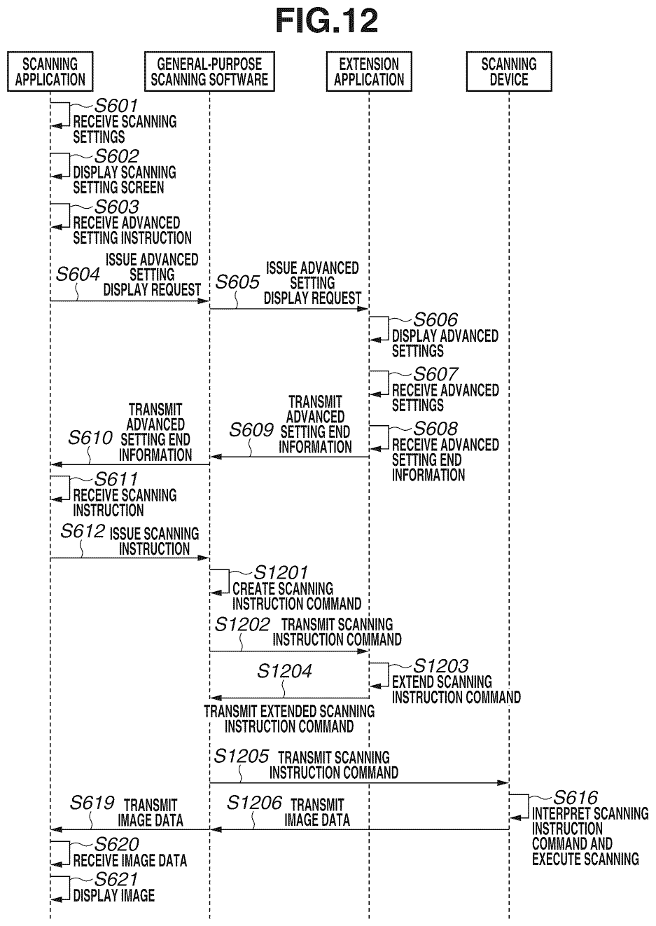

A processing sequence for the scanning application 201, the general-purpose scanning software 202, the extension application 204, and the scanning device 102 after the scanning application 201 have received scanning settings is described with reference to FIG. 12. In FIG. 12, same step numbers are used to designate the same steps in FIG. 6, and the redundant descriptions are omitted. Differences between FIG. 12 and FIG. 6 are mainly described. Steps other than the steps for the scanning device 102 illustrated in FIG. 12 are carried out by the CPU 111 loading the scanning application 201, the general-purpose scanning software 202, and the extension application 204 into the RAM 113 from the external storage device 114 and executing these applications. Each step for the scanning device 102 illustrated in FIG. 12 is implemented by the CPU 191 of the scanning device 102 loading programs stored in the ROM 192 or the external storage device 199 into the RAM 193 and executing the programs.

In step S1201, the general-purpose scanning software 202 creates a scanning instruction command. In this processing, functions that are not supported by the general-purpose scanning software 202 are not described in the scanning instruction command.

In step S1202, the general-purpose scanning software 202 transmits the created scanning instruction command to the extension application 204.

In step S1203, the extension application 204 adds and modifies an instruction command for functions that are not supported by the general-purpose scanning software 202 in the received scanning instruction command or changes existing instructions, to extend commands. In the present embodiment, the scanning instruction command created by the general-purpose scanning software 202 in step S1201 does not include the brightness adjustment setting, and thus the brightness adjustment setting is added.

In step S1204, the extension application 204 transmits the extended scanning instruction command to the general-purpose scanning software 202.

In step S1205, the general-purpose scanning software 202 transmits the scanning instruction command to the scanning device 102 to issue a scanning instruction.

In step S1206, the general-purpose scanning software 202 receives image data from the scanning device 102.

### Scanning Processing Sequence (Image Editing)

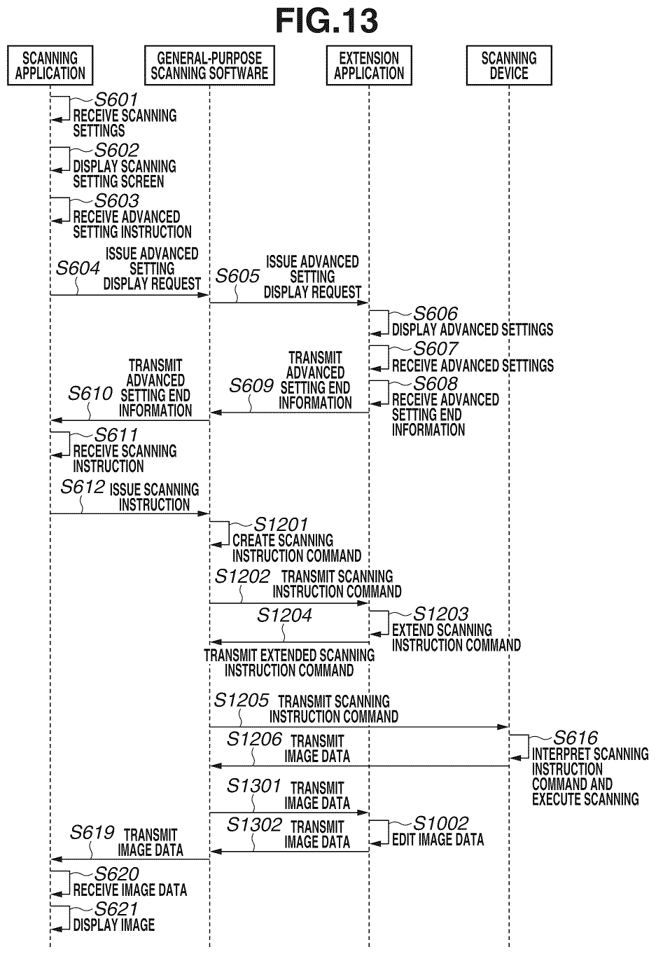

Next, a processing sequence for the extension application 204 to perform image editing processing when the general-purpose scanning software 202 and the scanning device 102 exchange information is described with reference to FIG. 13. In FIG. 13, same step numbers are used to designate the same steps in FIG. 12, and the redundant descriptions are omitted. Differences between FIG. 13 and FIG. 12 are mainly described. Steps other than the steps for the scanning device 102 illustrated in FIG. 13 are implemented by the CPU 111 loading the scanning application 201, the general-purpose scanning software 202, and the extension application 204 into the RAM 113 from the external storage device 114 and executing these applications. Each step for the scanning device 102 illustrated in FIG. 13 is implemented by the CPU 191 of the scanning device 102 loading programs stored in the ROM 192 or the external storage device 199 into the RAM 193 and executing the programs.

In step S1301, the general-purpose scanning software 202 transmits the received image data to the extension application 204.

In step S1002, the extension application 204 performs image editing processing. In the present embodiment, brightness adjustment processing is executed on the received image data, based on the brightness adjustment setting set in processing similar to step S1104 illustrated in FIG. 11.

In step S1302, the extension application 204 transmits the edited image data to the general-purpose scanning software 202.

As described above, in the second embodiment, the extension application 204 extends the brightness adjustment designation command, whereby the scanning device 102 can implement the brightness adjustment function and provide the user with the brightness adjustment function.

### Fourth Embodiment

A fourth embodiment of the present disclosure will be described below. The first to third embodiments described above illustrate a configuration example in which commands to be used in the standard protocol are extended and the extended commands are exchanged with the scanning device 102.

The fourth embodiment illustrates a configuration example in which commands to be used in the standard protocol are not extended and information about functions that are supported only by the extension application 204 is exchanged with the scanning device 102 using another command.

Differences from the above-described embodiments are described below.

### Scanning Processing Procedure (Transmission of Another Command)

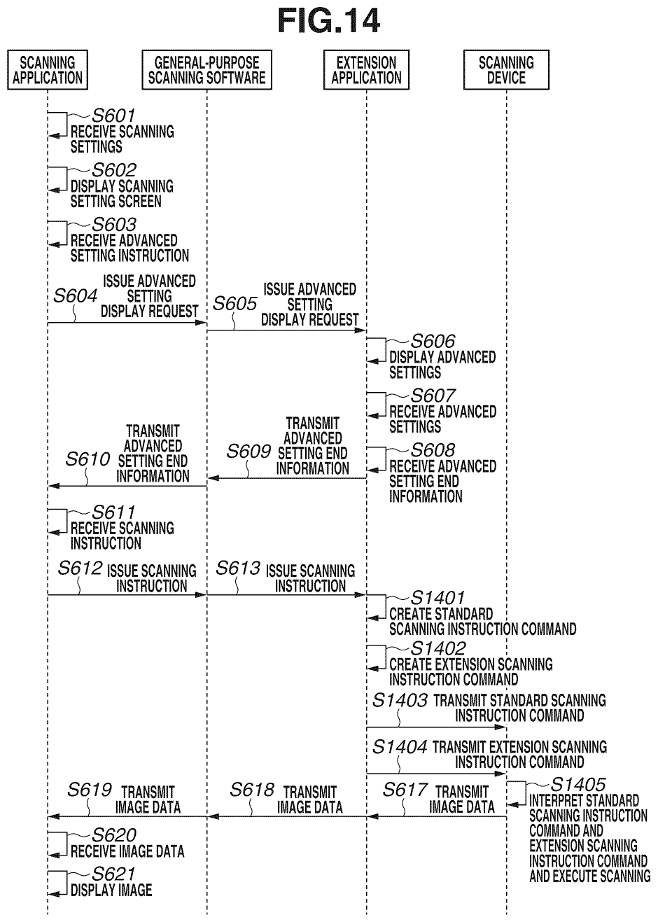

A processing procedure for the scanning application 201, the general-purpose scanning software 202, the extension application 204, and the scanning device 102 after the scanning application 201 has received scanning settings is described with reference to FIG. 14. Steps other than the steps for the scanning device 102 illustrated in FIG. 14 are carried out by the CPU 111 loading the scanning application 201, the general-purpose scanning software 202, and the extension application 204 into the RAM 113 from the external storage device 114 and executes these applications. Each step for the scanning device 102 illustrated in FIG. 14 is implemented by the CPU 191 of the scanning device 102 loading programs stored in the ROM 192 or the external storage device 199 into the RAM 193 and executing the programs. In FIG. 14, same step numbers are used to designate the same steps in FIG. 6, and the redundant descriptions are omitted. Differences between FIG. 14 and FIG. 6 are mainly described.

In step S1401, the general-purpose scanning software 202 creates a standard scanning instruction command that conforms to the standard protocol. In this case, information about functions that are not supported by the standard protocol is not described in the scanning instruction command.

In step S1402, the extension application 204 creates an extension scanning instruction command for the functions supported only by the extension application 204.

In step S1403, the extension application 204 transmits the standard scanning instruction command to the scanning device 102 to issue a scanning instruction.

In step S1404, the extension application 204 transmits the extension scanning instruction command to the scanning device 102 to issue a scanning instruction.

In step S1405, the scanning device 102 interprets the received standard scanning instruction command and extension scanning instruction command and executes scanning processing.

### Scanning Processing: Extension Application

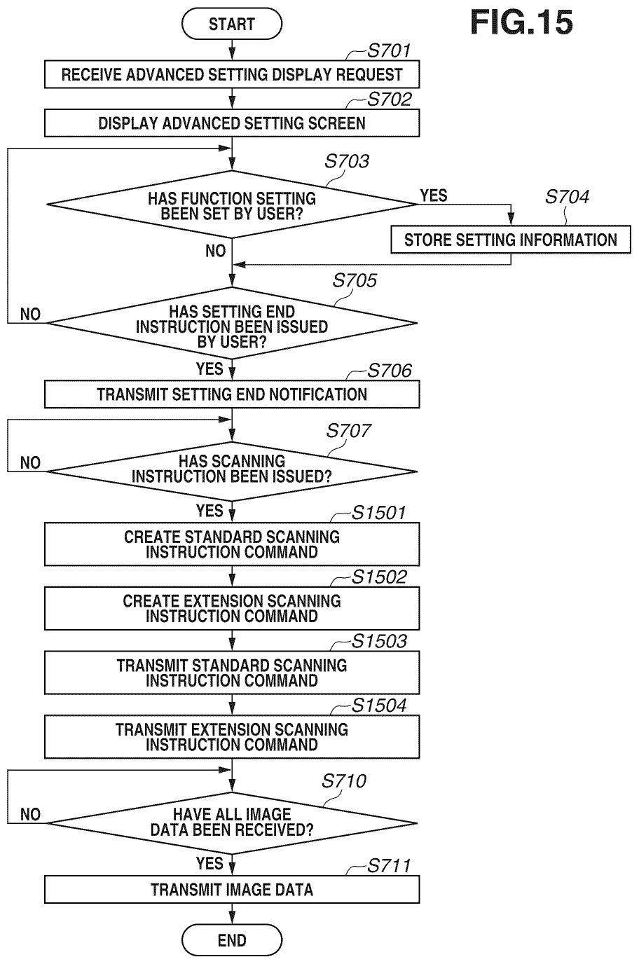

A procedure of scanning processing that is performed by the extension application 204 is described with reference to FIG. 15. Each step is implemented by the CPU 111 executing each unit as a program loaded into the RAM 113 from the external storage device 114. In FIG. 15, same step numbers are used to designate the same steps in FIG. 7, and the redundant descriptions are omitted. Differences between FIG. 15 and FIG. 7 are mainly described.

In step S1501, the extension application 204 creates a standard scanning instruction command that conforms to the standard protocol.

In step S1502, the extension application 204 creates an extension scanning instruction command for functions that are not supported by the standard protocol.

In step S1503, the extension application 204 transmits the standard scanning instruction command created in step S1501 to the scanning device 102.

In step S1504, the extension application 204 transmits the extension scanning instruction command created in step S1502 to the scanning device 102.

As described above, according to the fourth embodiment, the extension application 204 transmits another scanning instruction command for functions that are not supported by the standard protocol, to provide the user with the brightness adjustment function.

### Fifth Embodiment

A fifth embodiment of the present disclosure will be described in detail below.

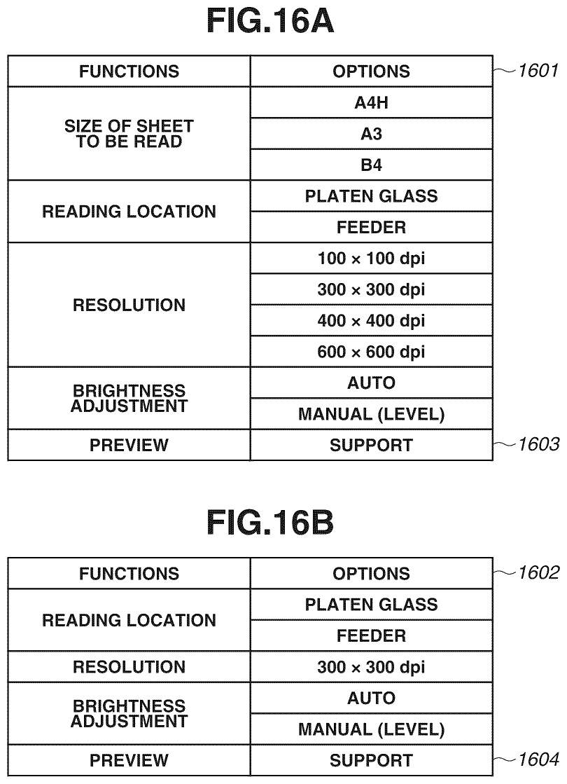

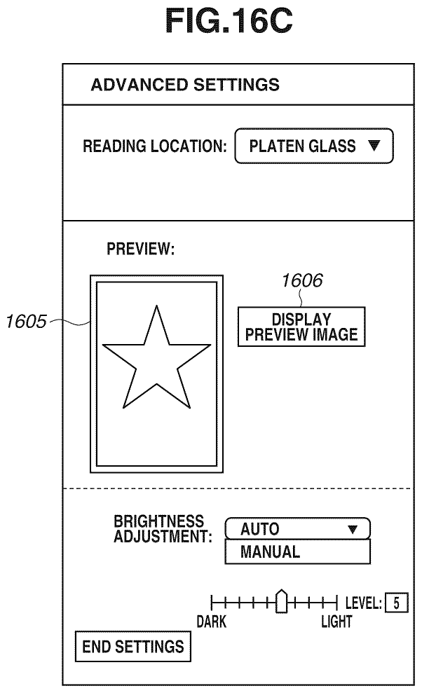

The fifth embodiment illustrates a method for displaying a preview image to enable the user to perform scanning processing while the user checks image data to be obtained in accordance with a difference in setting value for brightness adjustment. Differences from the above-described embodiments are described below with reference to FIGS. 16A to 16C.

FIG. 16A is a diagram illustrating a table 1601 as an example of a list of capability information obtained from the scanning device 102 according to the present embodiment. As illustrated in the table 1601, preview function support information 1603 has been obtained from the scanning device 102. As illustrated in a table 1602 of FIG. 16B, preview function support information 1604 indicates that the preview function is also supported by the extension application 204.

FIG. 16C is a diagram illustrating an example of the advanced setting screen on which a preview function can be used. FIG. 16C illustrates a region 1605 for display of a preview image and a control item 1606 for an instruction to display a preview image are displayed.

### Scanning Processing Sequence (Preview)

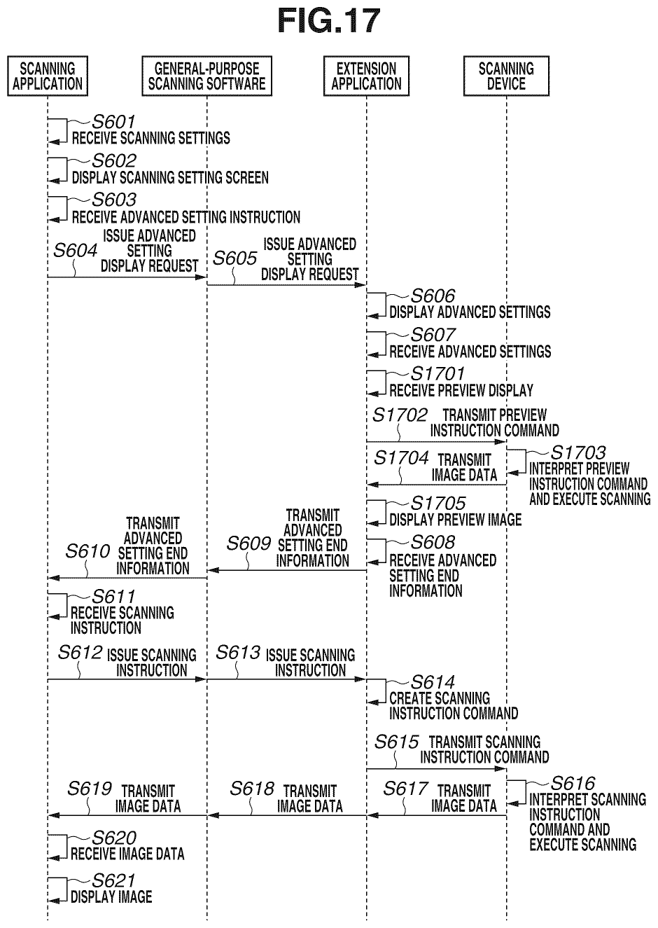

A processing sequence for the scanning application 201, the general-purpose scanning software 202, the extension application 204, and the scanning device 102 to display a preview image is described with reference to FIG. 17. Steps other than the steps for the scanning device 102 illustrated in FIG. 17 are carried out by the CPU 111 loading the scanning application 201, the general-purpose scanning software 202, and the extension application 204 into the RAM 113 from the external storage device 114 and executing these applications. Each step for the scanning device 102 illustrated in FIG. 17 is implemented by the CPU 191 of the scanning device 102 loading programs stored in the ROM 192 or the external storage device 199 into the RAM 193 and executing the programs. In FIG. 17, same step numbers are used to designate the same steps in FIG. 6, and the redundant descriptions are omitted. Differences between FIG. 17 and FIG. 6 are mainly described.

In step S1701, the extension application 204 receives a preview display request. The user can issue a preview display instruction by operating the pointing device 117 and the keyboard 118 to select the control item 1606.

In step S1702, the extension application 204 transmits a preview instruction command to the scanning device 102 to issue a preview scanning instruction. To issue the scanning instruction, the scanning instruction command is created based on settings received at this point. In the present embodiment, the scanning instruction command including the received brightness adjustment setting is created.

In step S1703, the scanning device 102 interprets the received preview instruction command and executes scanning processing. In the present embodiment, scanning processing in which instructed brightness adjustment processing is executed is carried out.

Next, in step S1704, the scanning device 102 transmits the generated image data to the extension application 204.

In step S1705, the extension application 204 displays the received preview image.

### Scanning Processing: Extension Application

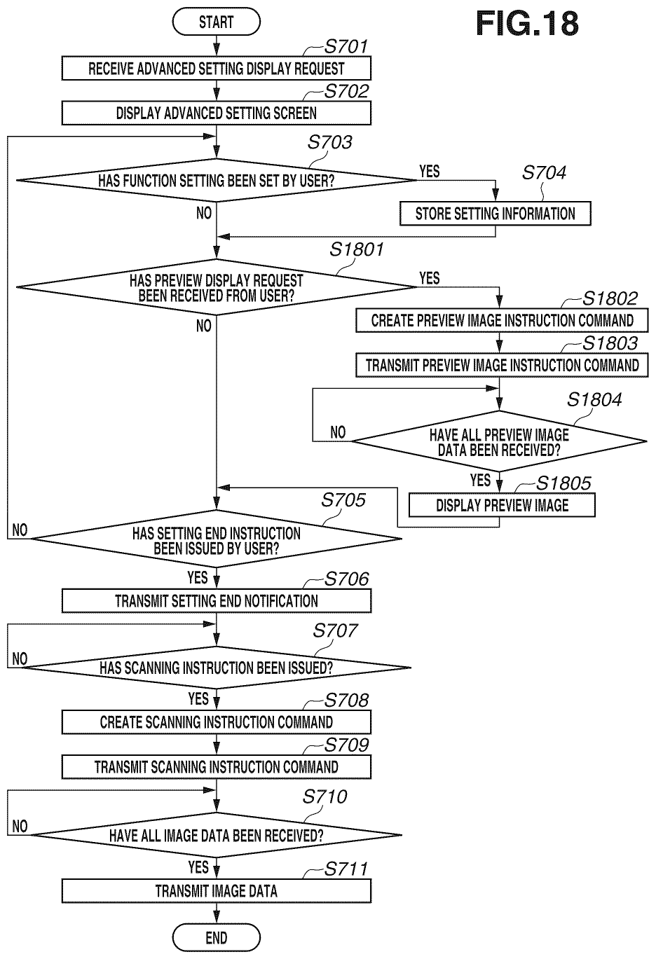

A procedure of scanning processing that is executed by the extension application 204 is described with reference to FIG. 18. Each step is implemented by the CPU 111 executing each unit which is a program loaded into the RAM 113 from the external storage device 114. In FIG. 18, same step numbers are used to designate the same steps in FIG. 7, and the redundant descriptions are omitted. Differences between FIG. 18 and FIG. 7 are mainly described.

In step S1801, the scanning setting screen extension unit 205 determines whether a preview display request has been received from the user. In a case where the preview display request has been received (YES in step S1801), the processing proceeds to step S1802. In a case where the preview display request has not been received (NO in step S1801), the processing proceeds to step S705.

In step S1802, the extension application 204 creates a preview image instruction command based on the setting information stored in step S704.

Examples of a method for creating the preview image instruction command in step S1802 include a method of extending a command to be used in the standard protocol, like in the scanning instruction command. Examples of the extension method include a method of describing a dedicated command in an extension region of a command to be used in the standard protocol. Other examples of the extension method include a method of adding a command of a particular standard to the end of a command to be used in the standard protocol, and a method in which a command to be used in the standard protocol is replaced by a proprietary command system by the extension application 204.

In the case of issuing an instruction from the extension application 204, the instruction may be issued and communication may be established using a protocol unique to the vendor regardless of the standard protocol.

In step S1803, the extension application 204 transmits the preview image instruction command to the scanning device 102 to issue a scanning instruction.

In step S1804, the extension application 204 determines whether all preview image data have been received from the scanning device 102. In a case where all preview image data have been received (YES in step S1804), the processing proceeds to step S1805. In a case where not all preview image data have been received (NO in step S1804), the processing returns to step S1804 to determine whether all preview image data have been received from the scanning device 102.

In step S1805, the extension application 204 displays the received preview image data.

In the present embodiment, image data generated by the same processing as that on actual image data is used as a preview image. Alternatively, image data exclusively used for preview may be generated. For example, the resolution may be reduced or the compression ratio may be increased to reduce the size of an image so that a preview image can be displayed at high speed.

The preview image may be discarded after the advanced settings end information is received in step S608 or when the advanced settings are cancelled, or the preview image may be stored until final image data is obtained so as to display the preview image when advanced settings are received again.

Next, a method in which the image data editing unit 207 updates a preview image in a case where the image data editing unit 207 in the extension application 204 is capable of performing image processing when a setting change is performed after the preview image is displayed is described. In this case, scanning by the scanning device 102 is not to be executed, and the user can be provided with a preview image of a final output easily and rapidly although the preview image is different from actual final image data. For example, in a case of brightness adjustment processing according to the present embodiment, the user can visualize how an image changes by changing setting values.

### Preview Image Update Processing: Extension Application

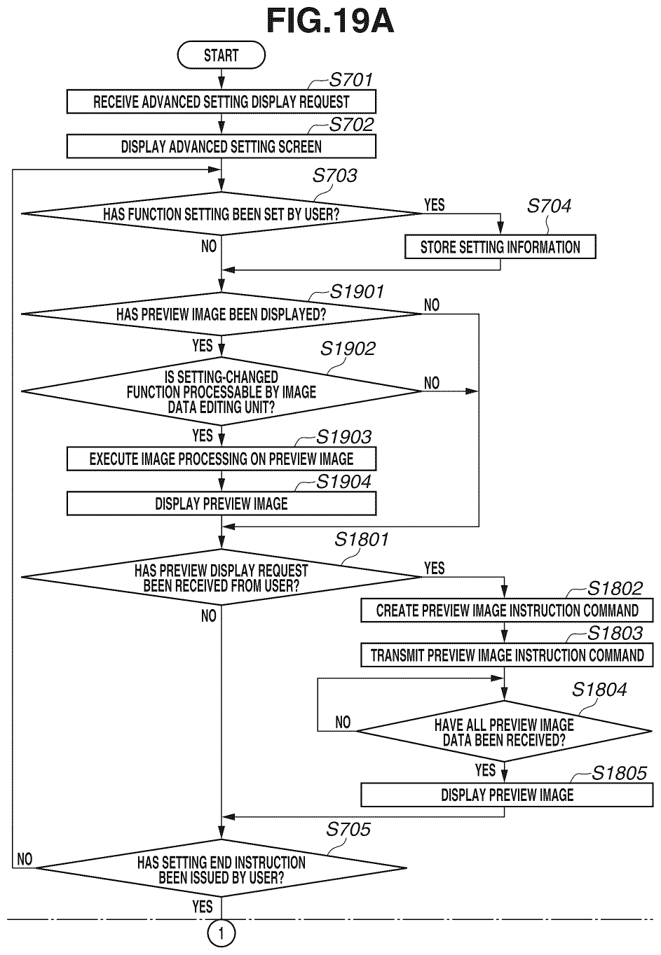

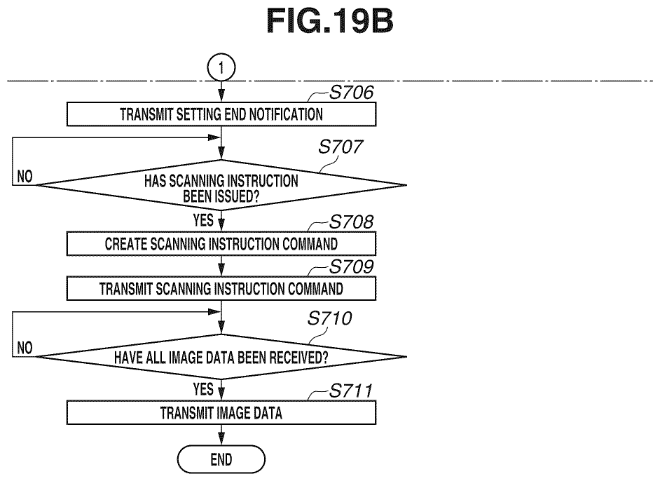

A procedure of preview image update processing that is performed by the extension application 204 is described with reference to FIGS. 19A and 19B. Each step is implemented by the CPU 111 loading each unit which is a program into the RAM 113 from the external storage device 114. In FIGS. 19A and 19B, same step numbers are used to designate the same steps in FIG. 18, and the redundant descriptions are omitted. Differences between FIGS. 19A and 19B and FIG. 18 are mainly described.

In step S1901, the extension application 204 determines whether the preview image has been already displayed. In a case where the extension application 204 determines that the preview image has been already displayed (YES in step S1901), the processing proceeds to step S1801. In a case where the extension application 204 determines that the preview image has not been displayed (NO in step S1901), the processing proceeds to step S1902.

In step S1902, the extension application 204 determines whether a setting change function received in step S703 can be processed by the image data editing unit 207. In a case where the extension application 204 determines that the setting change function can be processed by the image data editing unit 207 (YES in step S1902), the processing proceeds to step S1903. In a case where the extension application 204 determines that the setting change function is unable to be processed by the image data editing unit 207 (NO in step S1902), the processing proceeds to step S1801. In the present embodiment, the brightness adjustment processing can be performed by the image data editing unit 207, and thus the processing proceeds to step S1903.

In step S1903, the image data editing unit 207 performs image processing on the preview image.

In step S1904, the extension application 204 displays preview image data on which image processing has been performed.

A configuration example in which, after a preview image is displayed, the preview image is directly transmitted to the scanning application 201 without performing scanning again in a case where it is determined that the user wishes to use previewed image data as it is will be described.

### Advanced Setting Screen

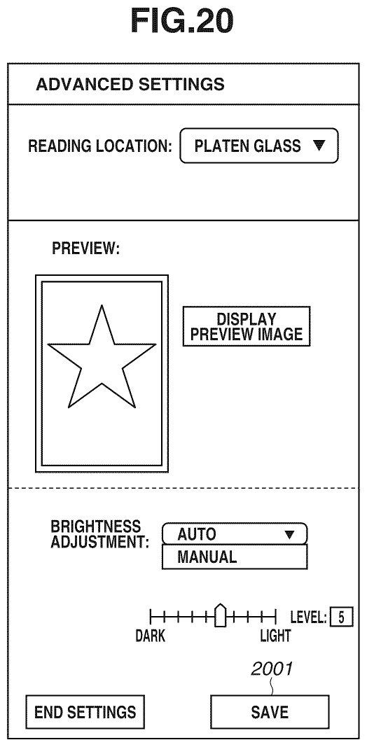

FIG. 20 is a diagram illustrating an example of the advanced setting screen on which a preview image can be saved. FIG. 20 illustrates a control item 2001 for instructing to save a preview image. In response to the control item 2001 being pressed, preview image saving processing is executed.

### Scanning Processing procedure (Use of Preview Image Data)

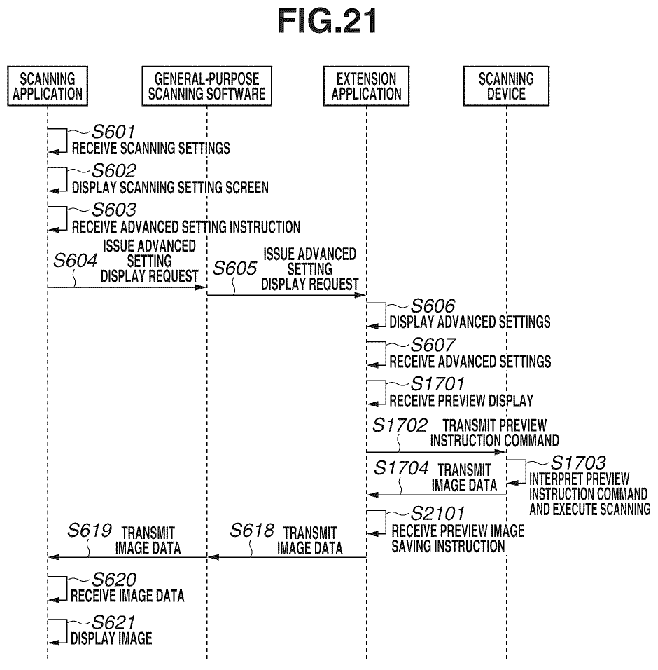

A processing procedure for the scanning application 201, the general-purpose scanning software 202, the extension application 204, and the scanning device 102 to save a preview image is described with reference to FIG. 21. Steps other than the steps for the scanning device 102 illustrated in FIG. 21 are carried out by the CPU 111 loading the scanning application 201, the general-purpose scanning software 202, and the extension application 204 into the RAM 113 from the external storage device 114 and executing these applications. Each step for the scanning device 102 illustrated in FIG. 21 is implemented by the CPU 191 of the scanning device 102 loading programs stored in the ROM 192 or the external storage device 199 into the RAM 193 and executing the programs. In FIG. 21, same step numbers are used to designate the same steps in FIG. 17, and the redundant descriptions are omitted. Differences between FIG. 13 and FIG. 12 are mainly described.

In step S1704, a scanned image is received.

In step S2101, the extension application 204 receives a preview image saving instruction. The user can issue the preview image saving instruction by operating the pointing device 117 and the keyboard 118 to select the control item 2001. In response to receipt of the preview image saving instruction, the extension application 204 transmits image data to the general-purpose scanning software 202. Further, the general-purpose scanning software 202 transmits the image data to the scanning application 201 so that the scanning application 201 can handle the image data.

### Scanning Processing: Extension Application

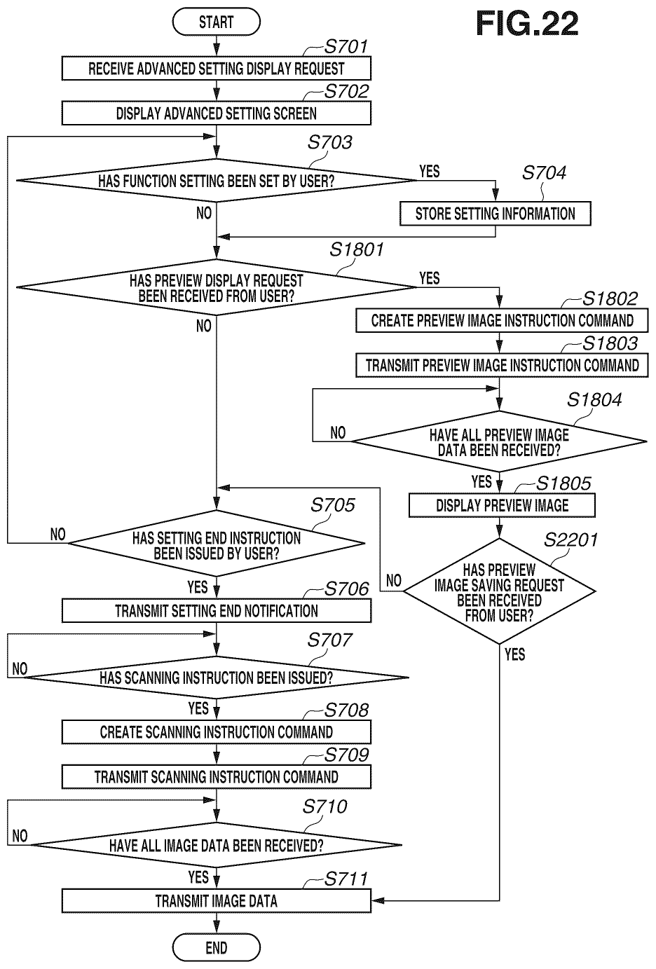

A procedure of scanning processing that is executed by the extension application 204 is described with reference to FIG. 22. Each step is implemented by the CPU 111 executing each unit which is a program loaded into the RAM 113 from the external storage device 114. In FIG. 22, same step numbers are used to designate the same steps in FIG. 18, and the redundant descriptions are omitted. Differences between FIG. 22 and FIG. 18 are mainly described.

In step S2201, the scanning setting screen extension unit 205 determines whether a preview image saving request has been received from the user. In a case where the scanning setting screen extension unit 205 determines that the preview image saving request has been received (YES in step S2201), the processing proceeds to step S711. In a case where the scanning setting screen extension unit 205 determines that the preview image saving request has not been received (NO in step S2201), the processing proceeds to step S705.

In step S711, the preview image is transmitted to the general-purpose scanning software 202.

A configuration example in which a preview image is displayed using image data preliminarily stored in the extension application 204 without using actual document data as the preview image is described. The use of preliminarily stored image data eliminates the need for scanning processing and makes it possible to provide the user with a preview image of a final output easily and rapidly although the preview image is different from actual image data. For example, in a case of the brightness adjustment processing according to the present embodiment, the user can visualize how an image changes by changing setting values.

### Scanning Processing Procedure (Use of Saved Image Data)

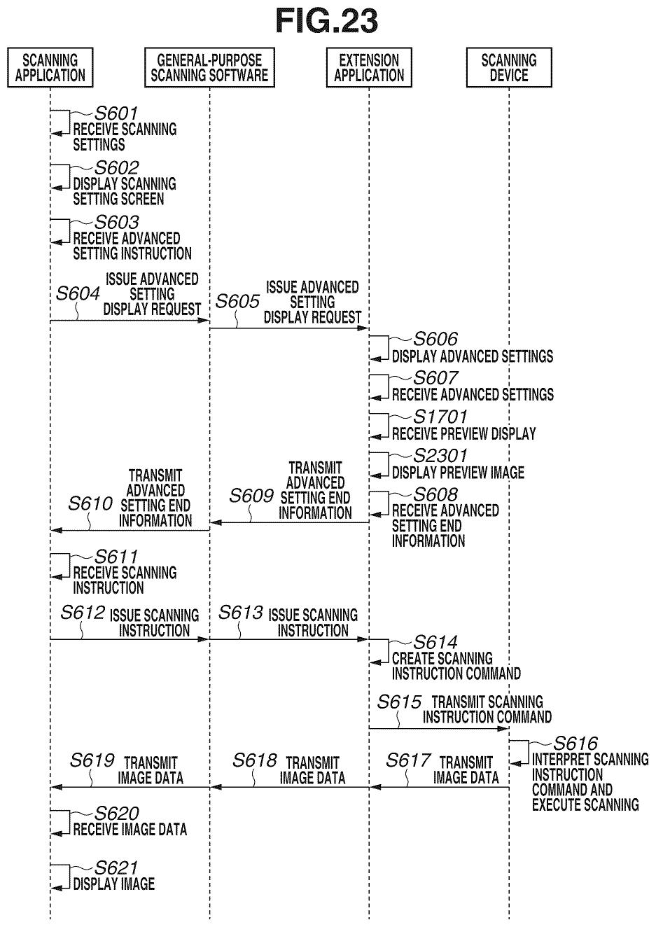

A processing procedure for the scanning application 201, the general-purpose scanning software 202, the extension application 204, and the scanning device 102 to display a preliminarily stored preview image is described with reference to FIG. 23. Steps other than the steps for the scanning device 102 illustrated in FIG. 23 are carried out by the CPU 111 loading the scanning application 201, the general-purpose scanning software 202, and the extension application 204 into the RAM 113 from the external storage device 114 and executes these applications. Each step for the scanning device 102 illustrated in FIG. 23 is implemented by the CPU 191 of the scanning device 102 loading programs stored in the ROM 192 or the external storage device 199 into the RAM 193 and executing the programs. In FIG. 23, same step numbers are used to designate the same steps in FIG. 17, and the redundant descriptions are omitted. Differences between FIG. 23 and FIG. 17 are mainly described.

In step S2301, the extension application 204 displays a preview image corresponding to the received settings.

In this processing, a plurality of preview images corresponding to various settings, respectively, may be stored separately as preview images to be displayed, and the preview image corresponding to the current setting may be selected from among the preview images to be displayed, or image processing may be performed each time on specific preview image data to be displayed.

### Scanning Processing (Preview Image Updating): Extension Application

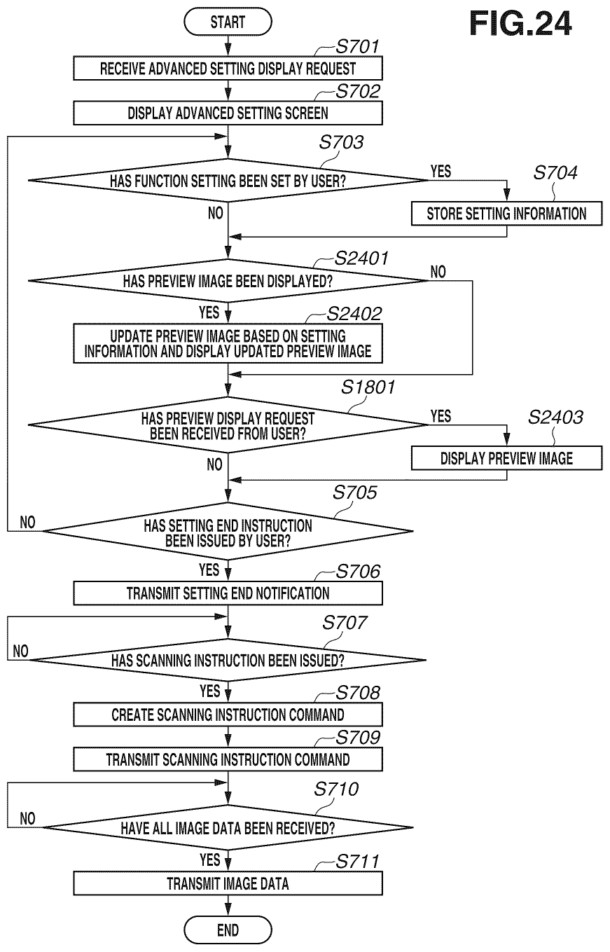

A procedure of preview image update processing that is performed by the extension application 204 is described with reference to FIG. 24. Each step is implemented by the CPU 111 executing each unit which is a program loaded into the RAM 113 from the external storage device 114. In FIG. 24, same step numbers are used to designate the same steps in FIG. 18, and the redundant descriptions are omitted. Differences between FIG. 24 and FIG. 18 are mainly described.

In step S2401, the extension application 204 determines whether a preview image has been already displayed. In a case where the extension application 204 determines that the preview image has been already displayed (YES in step S2401), the processing proceeds to step S2402. In a case where the extension application 204 determines that the preview image has not been displayed (NO in step S2401), the processing proceeds to step S1801.

In step S2402, the extension application 204 updates the preview image based on the settings and displays the updated preview image.

In step S1801, In a case where it is determined that a preview display request has been received from the user (YES in step S1801), the processing proceeds to step S2403.

In step S2403, the extension application 204 displays the preview image based on the settings.

As described above, in the fifth embodiment, the extension application 204 displays a preview image. Further, the preview image is changed based on settings, whereby the user is provided with the brightness adjustment function in such a form that the user can easily visualize an image of a final output.

According to the present disclosure, the brightness adjustment function becomes available to users by a program for extending functions of general-purpose scanning software that is available in common to scanning devices provided by a plurality of manufacturers.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-158729, filed Sep. 13, 2024, which is hereby incorporated by reference herein in its entirety.

What is claimed is:

1. A non-transitory computer-readable storage medium storing a program for supporting general-purpose software available to a plurality of image processing apparatuses manufactured by different manufacturers, wherein the program, when executed by a computer, causes an information processing apparatus to perform a method comprising:
causing a display unit to display a display screen to receive a brightness setting for an image of a document to be read by an image processing apparatus; and
outputting a reading instruction to cause the image processing apparatus to initiate reading of the document in accordance with the brightness setting received through the display screen.

2. The non-transitory storage medium according to claim 1, wherein an item that is displayed on the display screen to receive the brightness setting is changed based on reading capabilities of the image processing apparatus.

3. The non-transitory storage medium according to claim 2, wherein the brightness setting includes a setting for automatically adjusting brightness of an image of a document to be read.

4. The non-transitory storage medium according to claim 2, wherein the brightness setting includes changing brightness of an image of a document to a brightness level designated by a user.

5. The non-transitory storage medium according to claim 1, wherein the method further comprises:
determining whether the image processing apparatus is capable of executing a reading operation according to the brightness setting received on the display screen; and
changing, in response to determining that the image processing apparatus is incapable of executing the reading operation according to the brightness setting received on the display screen, brightness of image data obtained by reading the document based on the setting received on the display screen.

6. The non-transitory storage medium according to claim 5, wherein the method further comprises, in response to determining that the image processing apparatus is incapable of executing the reading operation according to the brightness setting, outputting an instruction command that excludes brightness adjustment.

7. The non-transitory storage medium according to claim 1, wherein the reading instruction is transmitted to the image processing apparatus via the general-purpose software.

8. The non-transitory storage medium according to claim 1, wherein the general-purpose software causes the information processing apparatus to obtain capability information from the image processing apparatus according to an Internet Printing Protocol (IPP).

9. The non-transitory storage medium according to claim 1, wherein the display unit is caused to display, as a preview image, the image of the document read by the image processing apparatus in response to the reading instruction.

10. A method for supporting general-purpose software available to a plurality of image processing apparatuses manufactured by different manufacturers, the method comprising:
displaying, via a display unit, a display screen configured to receive a brightness setting for an image of a document to be read by an image processing apparatus; and
outputting a reading instruction to cause the image processing apparatus to initiate reading of the document in accordance with the brightness setting received through the display screen.

11. An information processing apparatus including general-purpose software available to a plurality of image processing apparatuses manufactured by different manufacturers and a program that supports the general-purpose software, the information processing apparatus comprising:
a display unit configured to display a display screen by executing the program, the display screen being configured to receive a brightness setting for an image of a document to be read by an image processing apparatus; and
an output unit configured to output a reading instruction by executing the program, the reading instruction being an instruction to cause the image processing apparatus to initiate reading of the document in accordance with the brightness setting received through the display screen.
